(19) United States
(12) Patent Application Publication
(10) Pub. No.: US 2026/0050836 A1
(43) Pub. Date: Feb. 19, 2026

(54) SYSTEMS, METHODS, AND DEVICES FOR PERSONALIZED FOOD RECOMMENDATION USING MACHINE LEARNING

(71) Applicant: FlavorHawk Inc., Draper, UT (US)

(72) Inventor: Joseph Schwartz, San Diego, CA (US)

(21) Appl. No.: 19/300,515

(22) Filed: Aug. 14, 2025

Related U.S. Application Data
(60) Provisional application No. 63/684,305, filed on Aug. 16, 2024.

(51) Int. Cl. G06N 20/00

(52) U.S. Cl. CPC G06N 20/00

(57) ABSTRACT

A method for generating food recommendations includes obtaining food item files from online sources. Ingredients are identified from the food items. The food item files are tagged with metadata identifying the ingredients. A first set of vectors is generated that represent values for each of the food items and the ingredients. Food preferences are received from a user input. Ingredients are identified from the user input food preferences. A second set of vectors is generated that represent the user preferences based on the user input. The first set of vectors are compared to the second set of vectors. Vectors are selected from the first set of vectors based on similarity scores between the vector sets that meet or exceed a similarity threshold. Menu items are identified with food items that match the selected vectors. The identified menu items are provided as a recommendation.

### CROSS-REFERENCE TO RELATED APPLICATIONS

This application claims priority to U.S. Application No. 63/684,305, filed Aug. 16, 2024, which is hereby incorporated by reference in its entirety.

### FIELD OF INVENTION

The present disclosure relates to machine learning systems for generating personalized recommendations, and more particularly to training machine learning models to generate personalized food-entity recommendations based on user preferences, dietary restrictions, and recipe databases.

### BACKGROUND

People are frequently confronted with the challenge of deciding what to eat, a phenomenon commonly referred to as “food friction.” This daily struggle affects millions of consumers who seek meals tailored to their individual tastes and preferences. The complexity of food selection is compounded by various factors including dietary restrictions, food allergies, personal ingredient preferences, and the overwhelming number of available options at restaurants and food establishments.

Many individuals have specific dietary requirements that complicate their food selection process. Common dietary restrictions include vegetarian and vegan lifestyles, religious dietary laws such as kosher and halal requirements, and medical conditions such as celiac disease requiring gluten-free options. Additionally, food allergies affect a substantial portion of the population, with the most prevalent being allergies to milk, eggs, fish, shellfish, tree nuts, peanuts, wheat, soybeans, and sesame. These restrictions and allergies create barriers to food discovery and limit the options available to consumers.

Beyond dietary restrictions, consumers often have particular preferences for specific ingredients, flavors, and cooking styles. Some individuals may prefer certain proteins, vegetables, or spices while actively avoiding others. These personal taste preferences are highly individualized and can vary significantly from person to person, making it challenging to provide generalized food recommendations that satisfy diverse palates.

When dining at unfamiliar restaurants or exploring new cuisines, consumers frequently struggle with menu selection. Traditional restaurant reviews typically provide general assessments of establishments but lack the granularity to evaluate individual menu items. This limitation leaves consumers without detailed information about specific dishes that might align with their personal preferences and dietary requirements.

Existing food recommendation systems often rely on broad categorizations or simple rating systems that fail to account for the nuanced nature of individual taste preferences. Many current approaches do not adequately consider the complex interplay between dietary restrictions, ingredient preferences, and personal taste profiles when generating recommendations.

The proliferation of food delivery platforms and restaurant discovery applications has created an abundance of dining options, which paradoxically can make decision-making more difficult rather than easier. Consumers are presented with extensive lists of restaurants and menu items without sufficient personalization to guide their choices effectively.

There exists a need for more sophisticated approaches to food recommendation that can process and analyze multiple data sources including user preferences, dietary restrictions, ingredient compositions, and historical dining patterns to provide personalized suggestions that align with individual needs and tastes.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computer program product for generating food recommendations is provided. The computer program product includes a non-transitory computer readable storage medium having program instructions embodied therewith. An execution of the program instructions cause a processor to obtain, by a food recommendation engine, food item files from online sources. Ingredients are identified from the food items. The food item files are tagged with metadata identifying the ingredients. A first set of vectors is generated that represent values for each of the food items and the ingredients. A plurality of food preferences is received from a user input via a user interface of a software application run on a computing device. One or more of the ingredients are identified from the user input food preferences. A second set of vectors is generated that represent the user preferences based on the user input. The first set of vectors are compared to the second set of vectors. Vectors are selected from the first set of vectors based on similarity scores between the vector sets that meet or exceed a similarity threshold. Menu items and menu sources are identified with one or more food items that match the selected vectors. The food recommendation engine displays the identified menu items as a recommendation on the user interface of the computing device operated by an end user.

According to another aspect of the present disclosure, a computer-implemented method for generating food recommendations is provided. The method includes obtaining, by a food recommendation engine, food item files from online sources. Ingredients are identified from the food items. The food item files are tagged with metadata identifying the ingredients. A first set of vectors is generated that represent values for each of the food items and the ingredients. A plurality of food preferences is received from a user input via a user interface of a software application run on a computing device. One or more of the ingredients are identified from the user input food preferences. A second set of vectors is generated that represent the user preferences based on the user input. The first set of vectors are compared to the second set of vectors. Vectors are selected from the first set of vectors based on similarity scores between the vector sets that meet or exceed a similarity threshold. Menu items and menu sources are identified with one or more food items that match the selected vectors. The food recommendation engine displays the identified menu items as a recommendation on the user interface of the computing device operated by an end user.

According to another aspect of the disclosure, a computing device includes a processor and a memory coupled to the processor. The memory stores instructions to cause the processor to perform acts including obtaining, by a food recommendation engine, food item files from online sources. Ingredients are identified from the food items. The food item files are tagged with metadata identifying the ingredients. A first set of vectors is generated that represent values for each of the food items and the ingredients. A plurality of food preferences is received from a user input via a user interface of a software application run on a computing device. One or more of the ingredients are identified from the user input food preferences. A second set of vectors is generated that represent the user preferences based on the user input. The first set of vectors are compared to the second set of vectors. Vectors are selected from the first set of vectors based on similarity scores between the vector sets that meet or exceed a similarity threshold. Menu items and menu sources are identified with one or more food items that match the selected vectors. The food recommendation engine displays the identified menu items as a recommendation on the user interface of the computing device operated by an end user.

The foregoing general description of the illustrative embodiments and the following detailed description thereof are merely exemplary aspects of the teachings of this disclosure and are not restrictive.

### BRIEF DESCRIPTION OF THE DRAWINGS

Non-limiting and non-exhaustive examples are described with reference to the following figures.

FIG. 1 is a block a diagram of a system, in accordance with an embodiment of the subject technology.

FIG. 2 is a flowchart of a food recommendation process, in accordance with an embodiment.

FIG. 3 is a flowchart of a food data pre-processing method, consistent with embodiments.

FIG. 4 is a flowchart of a recommended food item retrieval process, consistent with embodiments.

FIG. 5 is a block diagram of a food recommendation engine architecture, consistent with embodiments.

FIG. 6 is a block diagram of a personalized dish recommendation environment, in accordance with an embodiment of the subject technology.

FIG. 7 is a block diagram of another personalized food-entity recommendation environment, in accordance with an embodiment of the subject technology.

FIG. 8 is a flowchart of a process for generating personalized dish recommendations, in accordance with an embodiment of the subject technology.

FIG. 9 is a flowchart of a process for training one or more machine learning models to generate personalized dish recommendations, in accordance with an embodiment of the subject technology.

FIG. 10 is a flowchart of a process for generating a flavor matching score, in accordance with an embodiment of the subject technology.

FIG. 11 is a flowchart of a process for training one or more machine learning models to generate personalized food-entity recommendations, in accordance with an embodiment of the subject technology.

FIG. 12 is a block diagram of a system for implementing one or more machine learning models, in accordance with an embodiment of the subject technology.

FIG. 13 is a block diagram of a computing device architecture of a system, consistent with embodiments of the subject technology.

FIG. 14 is a block diagram of a cloud computing architecture, consistent with embodiments of the subject technology.

FIG. 15 is a block diagram of a cloud architecture and organization structure, in accordance with an embodiment.

FIG. 16 is a block diagram of a data pipeline, in accordance with an embodiment.

FIG. 17 is a block diagram of a hybrid cloud data pipeline, in accordance with an embodiment.

FIG. 18 is a block diagram of an integration flow, in accordance with an embodiment.

FIG. 19 is a block diagram of a data pipeline, in accordance with another embodiment.

FIG. 20 is a screenshot of a user interface, in accordance with another embodiment.

FIG. 21 is a screenshot of a user interface, in accordance with another embodiment.

FIG. 22 is a screenshot of a user interface, in accordance with another embodiment.

FIG. 23 is a screenshot of a user interface, in accordance with another embodiment.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

### Overview

The present disclosure generally relates to processes that automate recommendations to consumer end users. There is a long felt need by consumers to address the daily problem of deciding what meal should be eaten next. As may be appreciated, many people cat a standard three meals a day. There is a common sentiment that many times people fall back on eating the same food items for lack of time or energy to consider all the possible meal choices. As a result, many individuals fall into a rut of eating the same foods in dismay because they cannot think of a different food to try. In addition, planning one's next meals for a day often requires considering what food is available on hand or needs to purchased. The thought process alone for meal planning consumes an inordinate amount of time during the day when time can be preciously used in other daily endeavors including working. Whether it be planning out meals to prepare or places to dine during a limited lunch break, the process of manually deciding what to cat and/or where to eat consumes more time than is ideal. To address these challenges, recommendation engine receives food related data from an end user including some or all of preferences, restrictions, dislikes, and previous dish choices to avoid for medical or lifestyle reasons.

The personalized food recommendation system of the subject technology addresses challenges in food discovery by transforming sparse menu descriptions into comprehensive ingredient profiles that enable precise dietary matching. Traditional restaurant recommendation systems operate at the establishment level using ratings and reviews. The subject technology delivers dish-level personalization by analyzing individual menu items and matching them to user preferences based on ingredient composition, dietary restrictions, and allergen considerations. The system processes menu data from diverse sources including restaurant websites, menu images, and structured data feeds to create detailed dish profiles that capture ingredient information typically absent from standard menu descriptions.

The system implements an artificial intelligence-powered data enrichment pipeline that transforms minimal menu text into structured dish profiles containing extracted ingredient information, dietary restriction classifications, and allergen data. Menu descriptions such as “pico de gallo” (or other known dish names) may be processed to identify constituent ingredients including tomatoes, onions, cilantro, and garlic, enabling the system to match dishes with users who have specific ingredient preferences or aversions. The enrichment process operates through multiple specialized classification functions that analyze dish characteristics, extract ingredient lists, evaluate dietary compliance, and identify potential allergen risks across large datasets of menu items.

In one embodiment, vector-based matching technology is used that enables the system to represent both dish characteristics and user preferences as high-dimensional mathematical vectors that capture semantic relationships between ingredients and food attributes. The system may generate vector embeddings for each processed dish profile using for example, machine learning models, creating numerical representations that encode ingredient properties, flavor profiles, and culinary relationships in a format suitable for similarity calculations. User preferences collected through dietary restrictions, ingredient likes and dislikes, and geographic location information may be similarly vectorized to enable direct comparison with dish profiles through mathematical similarity measures.

The recommendation process applies multi-stage filtering to optimize performance and accuracy across large datasets containing millions of dishes from hundreds of thousands of restaurant locations. Geographic filtering may identify food establishments within specified distances from user locations, while dietary constraint filtering eliminates dishes that conflict with user dietary restrictions or allergen requirements before computationally intensive vector operations. Vector similarity matching between user preference vectors and filtered dish embeddings identifies semantically similar dishes based on ingredient preferences, with results ranked according to similarity scores combined with contextual factors including geographic proximity and restaurant availability.

Real-time processing capabilities enable the system to handle dynamic user preference updates and location changes while maintaining sub-second response times for recommendation queries. The system may vectorize user preferences at query time to accommodate changing dietary needs, location-based constraints, and situational factors that influence food choices. Contextual matching incorporates real-time user constraints including proximity settings, price range preferences, dining environment factors, and service type preferences to deliver recommendations that align with immediate user needs and circumstances.

### Example Architecture

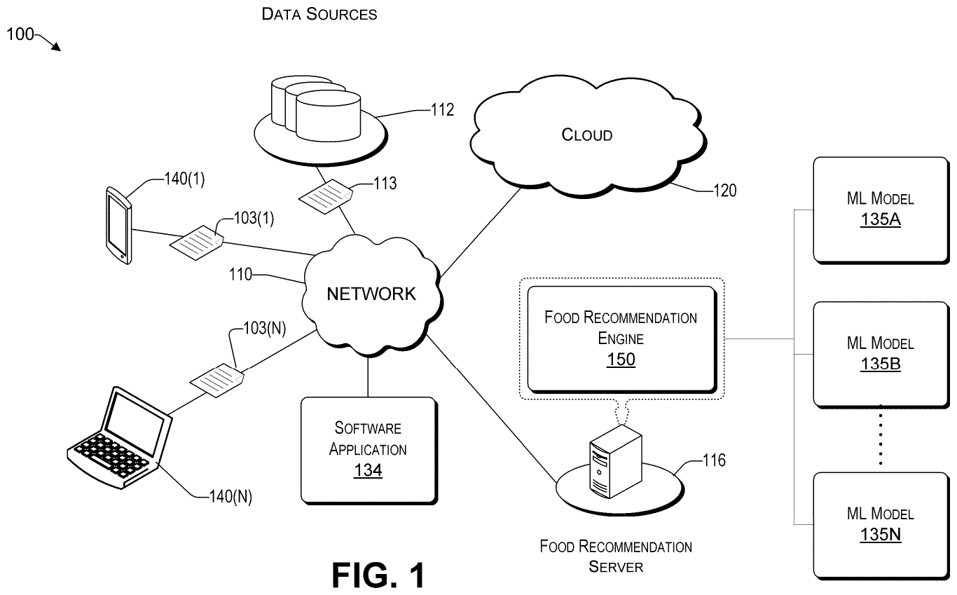

FIG. 1 illustrates an example platform architecture system 100 for automated food recommendation generation. In some cases, the system 100 may be configured to support multiple tenants and provide services such as software-as-a-service, platform-as-a-service, or infrastructure-as-a-service. Some embodiments may cooperate with white-label web applications, externally branded apps (airline apps, chain restaurant apps), API services, and MCP (Model Context Protocol) servers for agent integration. These deployment patterns are configured to provide personalized dish recommendations through third-party branded interfaces and programmatic access.

Platform architecture system 100 includes a network 110 that allows various computing devices 140(1) to 140(N) (sometimes referred to generally and in the aggregate as “computing device(s) 140” or as “client devices 140”) to communicate with each other, as well as other elements that are connected to the network 110, such as data sources 112, a food recommendation server 116, and the cloud 120.

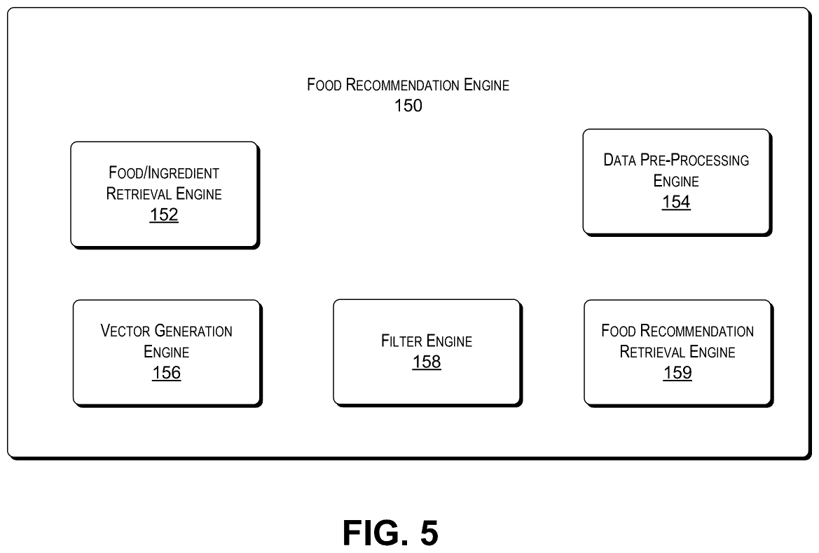

The food recommendation server 116 may operate a food recommendation engine 150. The food recommendation engine 150 may internally include a food/ingredient retrieval engine 152, a data pre-processing engine 154, a vector generation engine 156, a filter engine 158, and a food recommendation retrieval engine 159 (See FIG. 5). In the subject disclosure, the food recommendation server 116 receives food related information and food files from a variety of sources and the food recommendation engine 150 may process that food data under a variety of approaches as described above and below. One approach uses vectorization of data and vector matching to determine recommendations, which may be performed within the food recommendation server 116 (or a group of servers) or in a cloud-based environment. Some embodiments use machine learning. For example, the food recommendation engine may include one or more machine learning (ML) models 135A, 135B, to 135N (sometimes referred to in the aggregate or generally as “ML model(s) 135”). As will be explained in more detail below, the ML models 135 may receive data from end users operating one or more of the computing devices 140 through the network 110. End users may interface with some of the system 100 elements via a software application 134 that may be hosted by the system 100. In some cases, these client devices 140 may collect user preference data, dietary restrictions, and interaction patterns that are transmitted through the network 110 to the food recommendation engine 150 for processing by the machine learning models 135.

In an exemplary embodiment, the food recommendation engine 150 vectorizes the menu/dish dataset (including specific ingredients) and indexes the dataset for efficient search and retrieval. The vectors may expand over time to include classifications and dish types. User preference sets are vectorized at query time to be matched against the available dishes in the target dish repository. The recommendation engine 150 itself operates as a filtering, vector matching, and sorting process.

In an ML based embodiment, the data provided by end users is used to train and generate food recommendation models within the ML models 135. The food recommendation engine 150 accesses one or more of the ML models 135 to generate food recommendations to the end user. In some implementations, each ML model 135 may be assigned to a different modeling function. For example, ML model 135A may function as a rule-based classifier that receives user-specific data and generates scores for dishes based on user preferences. ML model 135B may operate as a text-to-embedding model that processes recipe data from the data source 112 and generates output vectors from the plurality of recipes. ML model 135N may receive inputs from both ML model 135A and ML model 135B, along with recipe data, to generate personalized dish recommendations for users. While this embodiment uses a plurality of ML models 135 to generate the output result to end users, some embodiments may use a single machine learning model generate the end output.

The food recommendations may be for example, food dishes to consider eating, meal plans to consider, restaurants to consider and/or dishes in a specific restaurant to order, alternate dishes to consider, and alternate ingredients to try in lieu of a different ingredient. The recommendations may be displayed to the end user through the software application 134 on the end user's computing device 140. In some embodiments, the recommendation types described (food dishes, meal plans, restaurants, specific restaurant dishes, alternates, ingredient substitutions) may be returned in multiple formats beyond the software application display: e.g., text result sets, API responses, and rich media including images and videos. As may be appreciated, the broader output capability supports the various integration scenarios mentioned earlier (white-label apps, branded apps, API services).

The network 110 may be, without limitation, a local area network (“LAN”), a virtual private network (“VPN”), a cellular network, the Internet, or a combination thereof. For example, the network 110 may include a mobile network that is communicatively coupled to a private network, sometimes referred to as an intranet that provides various ancillary services, such as communication with various application stores, libraries, and the Internet. The network 110 allows the food recommendation engine 150, which is a software program running on food recommendation server 116, to communicate with the data sources 112, computing devices 140(1) to 140(N), and/or the cloud 120, to provide data processing. The data sources 112 may include datasets associated with stored food data including nutritional values of food items, a corpus of recipes, recipe compositions, menus, food reviews, ingredient lists and other food-related metadata, that will be processed under one or more techniques described here. In some embodiments, a data packet 103(1) may be received by food recommendation engine 150 that includes a prompt for a food recommendation. The food recommendation engine 150 may call for retrieval of data from the data sources 112. Retrieved data may be in the form of a data packet 113. This data packet 113 can be received by the food recommendation engine 150 by either a push operation from the data source 112 or from a pull operation of the food recommendation engine 150. In one embodiment, the data processing including machine learning training and modeling for the food recommendation engine 150 is performed at least in part on the cloud 120.

For purposes of later discussion, several user devices appear in the drawing, to represent some examples of the computing devices that may be the source of data being analyzed depending on the task chosen. Aspects of the symbolic sequence data (e.g., 103(1) and 103(N)) may be communicated over the network 110 with the food recommendation engine 150. Today, user devices typically take the form of desktop computers, portable handsets, smart-phones, tablet computers, personal digital assistants (PDAs), and smart watches, although they may be implemented in other form factors, including consumer, and business electronic devices. While the data source 112 and the food recommendation engine 150 are illustrated by way of example to be on different platforms, it will be understood that in various embodiments, the data source 112 and the food recommendation server 116 may be combined. In some embodiments, the machine learning models 135 may be present in computing devices networked within the cloud network 120. In other embodiments, these computing platforms may be implemented by virtual computing devices in the form of virtual machines or software containers that are hosted in a cloud 120, thereby providing an elastic architecture for processing and storage.

### Methodology

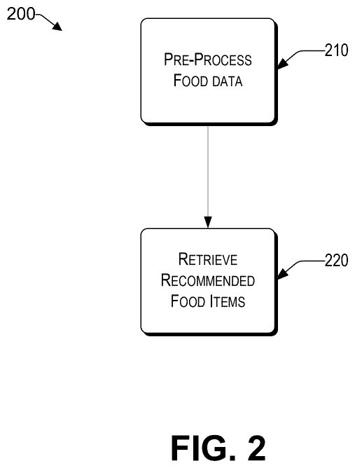

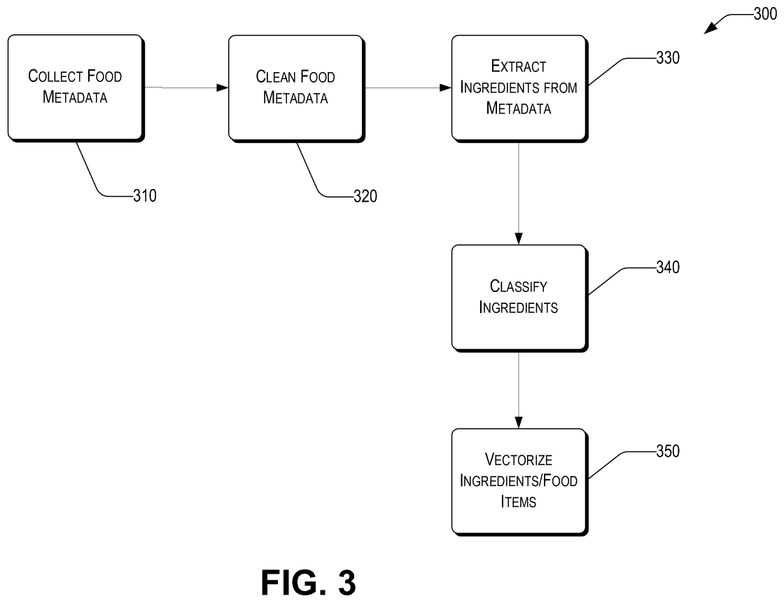

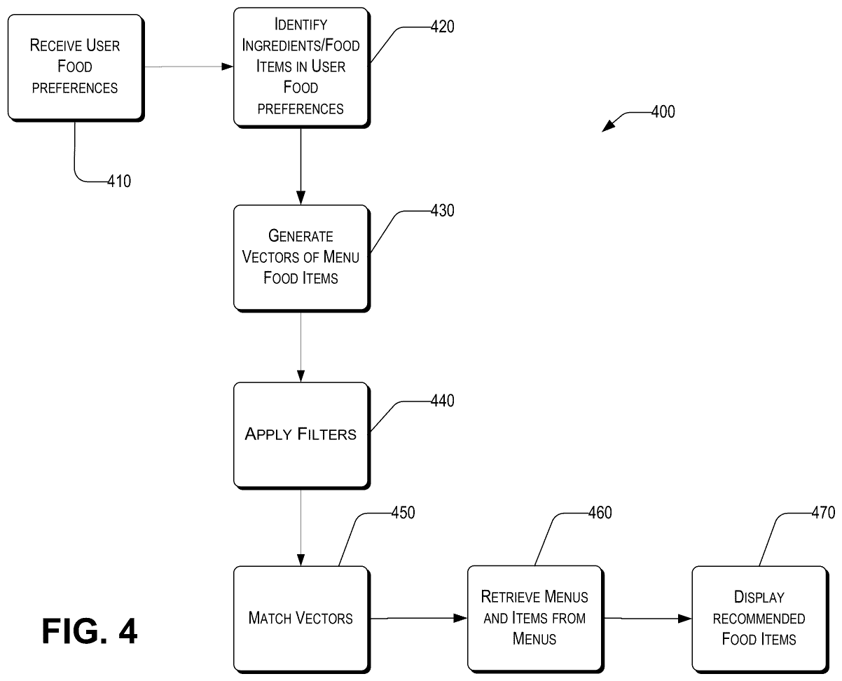

FIG. 2 shows a process 200 for generating food recommendations. There are generally two phases to the process 200. The first phase is for pre-processing food data 210 (for example, using pre-processing data engine 154). Pre-processed food data is prepared for analysis for use by the food recommendation engine 150 using any of a variety of processing approaches. One example pre-processing method is shown below in FIG. 3. The second phase includes retrieval of recommended food items 220. The analysis behind determining which recommended food items may use any of a variety of approaches. An example of food item retrieval recommendations is shown in FIG. 4.

FIG. 3 shows a method 300 for pre-processing food data according to an embodiment. The method 300 collects food files and food related metadata from a plurality of sources. One example source is menu data that may be obtained by accessing online menu files. In some embodiments, the method 300 may use artificial intelligence (A.I.) powered models that may transform raw menu data into structured dish profiles through a sequential processing workflow that addresses the semantic gap between sparse restaurant menu descriptions and comprehensive ingredient information. The method 300 may begin with collecting 310 food metadata from diverse sources including restaurant websites, menu images, and structured data feeds that provide varying levels of detail regarding dish characteristics and ingredient compositions via the food/ingredient retrieval engine 152. The recommendation engine 150 may perform 320 systematic cleaning processes (via the data pre-processing engine 154) that standardize formatting, remove artifacts, and consolidate fragmented descriptions while identifying entries that may require additional context enhancement for reliable classification. The cleaning phase may prepare menu data for subsequent processing stages by ensuring consistent data quality across diverse menu sources and formats received through the network system 100.

In some embodiments, the recommendation engine 150 may implement context enhancement capabilities that automatically retrieve additional dish information through web search when initial menu descriptions provide insufficient detail for reliable classification. Context enhancement processes may trigger when oversight agents within the pipeline evaluate menu descriptions and determine that available information may be inadequate for accurate ingredient extraction or dietary classification. In some cases, the context enhancement system may perform targeted web searches that prioritize first-party restaurant websites and official menu descriptions to obtain authoritative dish information. The enhanced descriptions obtained through web search may be integrated back into the classification pipeline while maintaining data provenance tracking for quality assurance and validation purposes.

The recommendation engine 150 may extract 330 ingredients from the food data by implementing a comprehensive ingredient glossary with numeric indexing that enables standardized ingredient identification and mapping across diverse menu formats and culinary descriptions. The ingredient glossary may contain standardized naming conventions, alternate spellings, and numeric indices that ensure uniform ingredient recognition across all processed dishes within the system. In some cases, the ingredient glossary may include foreign language alternative spellings and regional variations of ingredient names to support robust ingredient recognition across diverse menu formats and international cuisine descriptions. The glossary-based mapping approach may prevent duplicate ingredient entries through singular form standardization while enabling consistent categorization across large dish datasets spanning multiple restaurant types and geographic regions.

As further shown in FIG. 3, the recommendation engine 150 classifies 340 the extracted ingredients. For example, the recommendation engine 150 may execute six specialized artificial intelligence classification functions that operate on enhanced menu descriptions to generate comprehensive structured dish profiles. The classification functions may include dish type classification that analyzes enhanced descriptions to determine fundamental dish categories such as appetizers, entrees, desserts, beverages, side dishes, soups, salads, and snacks based on dish completeness and estimated portion sizes. Ingredient extraction may utilize the standardized ingredient glossary to identify specific food components within dish descriptions and map identified ingredients to corresponding glossary indices for consistent categorization. Dietary restriction analysis may evaluate extracted ingredient lists to assess compliance with various dietary frameworks including vegan, vegetarian, pescatarian, kosher, halal, ketogenic, paleolithic, and Atkins dietary approaches through cross-referencing ingredients against comprehensive dietary rules and preparation method considerations.

Food allergen detection may identify potential risks associated with nine major allergens comprising milk, eggs, fish, crustacean shellfish, tree nuts, peanuts, wheat, soybeans, and sesame through analysis of standardized ingredient lists and conservative detection methodologies that prioritize user safety. The allergen detection process may employ multi-layered analysis strategies that combine structured prompt-based context engineering, fine-tuned language models for nuanced determinations, and deterministic mappings for high-confidence identification of allergen-containing ingredients. In some cases, the allergen detection system may apply deliberately conservative detection approaches that minimize false negatives to ensure comprehensive flagging of potential allergen exposures even when ingredient information may be incomplete or ambiguous.

Cuisine category classification may assign dishes to specific cuisine types through analysis of dish names, ingredient combinations, preparation methods, and cultural associations derived from enhanced menu descriptions. The cuisine classification process may evaluate dishes against predefined cuisine categories and assign single most likely cuisine classifications based on ingredient patterns and culinary traditions. Restaurant category aggregation may synthesize individual dish classifications into restaurant-level metadata by collecting unique dish categories across complete menus and generating comprehensive category tags that describe overall culinary focus and category distributions of food establishments.

The recommendation engine 150 may generate 350 vectors via the vector generation engine 156) (See FIG. 5) for the ingredients and food items. The vectorization phase may transform structured dish profiles generated through the classification functions into high-dimensional mathematical representations suitable for similarity matching operations within the recommendation system. Vector embeddings may encode comprehensive ingredient profiles, dietary classifications, and allergen information in numerical formats that enable efficient similarity calculations between dish characteristics and user preferences. The vectorized dish data may be stored in searchable database systems configured for real-time similarity matching operations that support the personalized food recommendation processes within the network system 100.

In some embodiments, the vector generation process may utilize machine learning models to create numerical embeddings that capture semantic characteristics of ingredients and dish attributes in mathematical formats suitable for computational analysis. Vector embeddings generated from structured dish profiles may encode comprehensive ingredient information, dietary classifications, allergen data, and culinary relationships in high-dimensional spaces that preserve semantic meaning while enabling mathematical similarity calculations. The vectorization phase may represent the final transformation step that converts enriched textual dish data into numerical formats compatible with similarity search algorithms and recommendation matching processes.

The vector generation engine 156 may create 256-dimensional embeddings for each structured dish profile using text embedding models that transform ingredient lists and dish characteristics into numerical vector representations. In some cases, the vector generation process may utilize OpenAI text-embedding-3-small models as primary embedding sources that generate 256-dimensional vectors optimized for semantic similarity calculations across food-related textual content. The embedding generation process may analyze structured ingredient profiles, dietary restriction classifications, and allergen information to produce mathematical representations that capture ingredient relationships, culinary associations, and nutritional characteristics within the high-dimensional vector space. The 256-dimensional embedding format may provide sufficient representational capacity to encode complex ingredient interactions and dish attributes while maintaining computational efficiency for large-scale similarity matching operations.

The vector generation engine 156 may implement multiple embedding model sources to provide redundancy and cost optimization capabilities across different operational scenarios and processing requirements. AWS Bedrock services may serve as alternative embedding sources that provide cloud-based machine learning capabilities for vector generation when primary embedding models may be unavailable or when specific processing requirements favor alternative model architectures. In some cases, the vector generation engine may access additional language model APIs that offer specialized embedding capabilities or cost-effective processing options for high-volume vector generation tasks. The multi-source embedding approach may enable automatic fallback capabilities that maintain system reliability and performance when individual embedding services experience availability issues or capacity constraints.

As further shown in FIG. 3, the vector generation process may coordinate with the artificial intelligence classification functions to ensure consistent semantic encoding across all processed dish profiles within the system. The vector generation engine may receive structured dish profiles containing standardized ingredient lists, dietary restriction classifications, and allergen information from the classification pipeline and transform such structured data into mathematical vector representations. The embedding process may preserve semantic relationships between ingredients and dish characteristics by encoding similar food items with similar vector representations while maintaining sufficient separation between dissimilar dishes to enable accurate similarity matching. The vector generation process operates on the validated structured data from the classification pipeline, inheriting the quality assurance established during the data enrichment stage to ensure reliable mathematical representations for similarity matching operations.

FIG. 4 shows a method 400 of retrieving food item recommendations according to an embodiment. The food recommendation/retrieval engine 159 may receive 410 user preference data through multiple input channels that capture dietary restrictions, ingredient preferences, and geographic location information to enable personalized food recommendations. The user preference data collection process may begin when users interact with client devices or user devices to provide information about their dietary requirements, food preferences, and current location through structured input interfaces. User preference data may include macro dietary restrictions such as vegetarian, vegan, pescatarian, kosher, halal, ketogenic, paleolithic, and Atkins classifications that define broad dietary frameworks governing food choices.

The food recommendation/retrieval engine 159 may identify 420 ingredients/food items in the user preference data. The system may also collect specific ingredient preferences through like and dislike selections that capture user attitudes toward individual food components such as cilantro, mushrooms, seafood, spicy ingredients, or other polarizing food elements that significantly influence meal satisfaction.

The food recommendation/retrieval engine 159 may perform 430 a real-time user preference vectorization process that may transform collected user preference data into high-dimensional mathematical representations using the same machine learning models employed for dish profile vectorization. The vectorization process may operate at query time to accommodate dynamic preference changes and location-based constraints that may vary between different recommendation requests from the same user. User or group preference vectors may be generated by processing dietary restriction classifications, ingredient preference selections, and additional preference attributes” for broader coverage through text embedding models that create 256-dimensional numerical representations compatible with dish profile embeddings stored within the database system. The vectorization process may encode user dietary requirements and ingredient preferences in the same high-dimensional space used for dish representations, enabling direct mathematical similarity calculations between user preferences and available menu items.

Embodiments using machine learning models used for user preference vectorization may apply the same embedding algorithms and dimensional parameters utilized during dish profile processing to ensure semantic compatibility between user preference vectors and dish embedding representations. The vectorization process may transform structured user preference data including dietary restriction Boolean values, ingredient preference scores, and regional preference patterns into unified mathematical vectors that capture user food preferences in numerical formats suitable for similarity matching operations. In some cases, the user preference vectorization may weight different preference categories based on user-specified importance levels or system-learned preference patterns that reflect individual user priorities regarding dietary compliance, ingredient preferences, and geographic convenience factors.

The food recommendation engine 150 may include real-time processing capabilities that handle dynamic user preference updates and location changes to provide contextually relevant recommendations that reflect current user circumstances and immediate dining needs. The system may re-vectorize user preferences when users modify dietary restrictions, update ingredient preferences, or change geographic locations during active recommendation sessions. Real-time vectorization may enable the system to accommodate situational preference changes such as temporary dietary modifications, location-based cuisine preferences, or contextual dining constraints that may differ from baseline user preferences stored in user profiles. The dynamic vectorization process may maintain sub-second response times by utilizing efficient embedding generation algorithms and optimized data processing pipelines that minimize computational overhead during preference updates.

The structured JSON output format may organize vectorized user preference data in standardized data structures that facilitate immediate recommendation delivery and integration with downstream processing components within the food recommendation system. The JSON output may contain user preference vectors alongside associated metadata including dietary restriction classifications, ingredient preference mappings, geographic constraint parameters, and temporal preference indicators that provide comprehensive user context for recommendation algorithms. In some cases, the structured output may include preference confidence scores, priority weightings, and contextual flags that enable the recommendation engine to apply appropriate emphasis to different aspects of user preferences during similarity matching and ranking operations. The JSON format may also support incremental preference updates that enable the system to modify specific preference components without requiring complete user preference re-vectorization, improving system efficiency during dynamic preference adjustment scenarios.

The user preference vectorization process may coordinate with the food recommendation engine to ensure consistent semantic encoding between user preferences and dish profile representations throughout the recommendation workflow. The vectorization system may validate user preference vectors against dish embedding dimensional parameters and semantic consistency requirements to prevent compatibility issues during similarity matching operations. The real-time processing architecture may support concurrent user preference vectorization across multiple user sessions while maintaining system performance and response time standards for recommendation delivery. The vectorization process may also implement caching mechanisms that store frequently accessed user preference vectors to reduce computational overhead for repeat recommendation requests from the same users with stable preference profiles.

The food recommendation/retrieval engine 159 may apply 440 filters to a food recommendation operation. Embodiments may include a multi-stage filtering architecture that implements a sequential optimization approach that progressively narrows the searchable dataset while preserving recommendation quality across large dish databases containing millions of menu items from hundreds of thousands of restaurant locations. The filtering system may operate through distinct processing stages that apply different constraint types in a specific sequence designed to maximize computational efficiency during recommendation generation. Geographic filtering may serve as the initial stage that reduces the total searchable dataset from the complete national dish corpus to a manageable subset based on spatial proximity parameters specified by user location data. The multi-stage approach may enable the system to handle large-scale datasets by eliminating irrelevant options early in the processing workflow, thereby reducing computational overhead for subsequent similarity matching operations.

The geographic filtering stage may process user location coordinates against restaurant geolocation data using distance-based algorithms with configurable radius parameters that determine the spatial scope of restaurant consideration. Distance-based algorithms within the geographic filtering system may calculate spatial relationships between user coordinates and restaurant locations using mathematical distance formulas that account for geographic coordinate systems and spatial measurement units. In some cases, the geographic filtering may support configurable radius parameters that enable users to specify preferred travel distances ranging from immediate proximity searches within walking distance to broader regional searches that encompass metropolitan areas or multi-county regions. The geographic filtering process may utilize spatial indexing techniques that organize restaurant location data in data structures optimized for efficient proximity queries across large geographic datasets.

The geographic filtering system may implement dynamic radius adjustment capabilities that modify search distances based on restaurant density, cuisine availability, and user preference matching potential within different geographic areas. The filtering algorithms may expand search radii automatically when insufficient restaurant options exist within initial proximity parameters, while maintaining tighter geographic constraints in areas with high restaurant density to prevent overwhelming users with excessive options. Geographic filtering may also incorporate real-time location tracking that updates search parameters when users change locations during active recommendation sessions, enabling the system to provide contextually relevant recommendations that reflect current user positioning. The geographic proximity filtering may coordinate with mapping services and location databases to ensure accurate distance calculations and account for transportation infrastructure, traffic patterns, and accessibility factors that influence actual travel convenience.

The dietary constraint filtering stage may operate as Boolean filtering that eliminates dishes incompatible with user dietary restrictions and allergen requirements before computationally intensive vector similarity operations. Boolean filtering within the dietary constraint system may evaluate structured dish profiles against user-specified dietary frameworks including vegetarian, vegan, pescatarian, kosher, halal, ketogenic, paleolithic, and other specialized dietary approaches through binary compatibility assessments. The dietary filtering process may access comprehensive dietary restriction classifications generated during the data enrichment pipeline to determine dish eligibility based on ingredient compositions, preparation methods, and cross-contamination considerations. In some cases, the dietary constraint filtering may implement hierarchical filtering logic that applies multiple dietary restrictions simultaneously while maintaining logical consistency between overlapping dietary requirements.

An allergen exclusion filtering component may identify and eliminate dishes containing any of the nine major allergens including milk, eggs, fish, crustacean shellfish, tree nuts, peanuts, wheat, soybeans, and sesame based on comprehensive allergen detection data generated during dish profile processing. The allergen filtering system may implement conservative exclusion methodologies that prioritize user safety by removing dishes with potential allergen risks even when ingredient information may be incomplete or ambiguous. Allergen exclusion filtering may operate through deterministic matching algorithms that cross-reference dish ingredient profiles against user-specified allergen restrictions using Boolean logic that ensures complete elimination of incompatible menu items. The filtering process may also account for cross-contamination risks and shared preparation environments that could introduce allergen exposure through indirect contact during food preparation processes.

The multi-stage filtering architecture may coordinate filtering operations to optimize computational performance across large dish datasets by reducing the candidate pool before executing vector similarity matching algorithms. The filtering sequence may eliminate the majority of incompatible dishes through geographic and dietary constraints, thereby reducing the vector search space from millions of potential dishes to thousands of geographically accessible and dietarily compatible options. In some cases, the filtering system may process geographic and dietary constraints in parallel to minimize processing time while maintaining filtering accuracy and completeness. The computational efficiency improvements achieved through pre-filtering may enable the system to maintain sub-second response times for recommendation queries even when processing national-scale dish databases with comprehensive geographic coverage.

The contextual matching capabilities may extend beyond basic geographic and dietary filtering to incorporate real-time user constraints including proximity settings, price range preferences, dining environment factors, group size accommodations, and service type preferences. Proximity settings within the contextual matching system may enable users to specify travel convenience preferences that balance geographic distance against recommendation quality, allowing users to prioritize local convenience or accept greater travel distances for higher-quality matches. Price range preferences may filter restaurants and dishes based on user-specified budget constraints that eliminate options outside acceptable cost parameters while maintaining recommendation diversity across different price tiers. The contextual matching system may also process dining environment factors such as outdoor seating availability, noise levels, ambiance preferences, and accessibility requirements that influence restaurant suitability for specific dining scenarios.

The contextual factors may include real-time restaurant operational status that eliminates closed establishments, temporarily unavailable menu items, and restaurants with limited service capacity during peak demand periods. Estimated wait times may be incorporated into the filtering process to help users make informed decisions about restaurant selection based on time constraints and dining schedule requirements. User-specified proximity weighting parameters may enable dynamic adjustment of geographic importance relative to other recommendation factors, allowing users to emphasize convenience over flavor matching or vice versa based on situational preferences. The contextual matching system may also accommodate group size considerations that filter restaurants based on seating capacity, reservation availability, and party accommodation capabilities to ensure recommended establishments can serve the intended dining group size.

The multi-stage filtering system may implement adaptive filtering strategies that modify constraint application based on result availability and user preference satisfaction within different geographic areas and dietary categories. When initial filtering parameters produce insufficient recommendation options, the system may progressively relax certain constraints while maintaining safety-related restrictions such as allergen exclusions and dietary compliance requirements. The filtering architecture may also support preference learning capabilities that adjust filtering parameters based on user selection patterns and feedback to improve recommendation relevance over time. In some cases, the multi-stage filtering may coordinate with caching mechanisms that store frequently accessed filtering results to reduce computational overhead for similar recommendation requests from users with comparable preference profiles and geographic locations.

The food recommendation/retrieval engine 159 may perform 450 a vector similarity matching process that compares user preference vectors with dish embeddings stored in the database system to identify semantically similar dishes based on ingredient preferences and dietary characteristics. The similarity matching algorithms may operate on the filtered dataset remaining after geographic proximity filtering and dietary constraint filtering have eliminated incompatible menu options from consideration. Vector similarity calculations may utilize mathematical distance measures that quantify semantic relationships between user preference vectors and dish embedding representations within the high-dimensional vector space. The matching process may evaluate numerical proximity between user preference vectors and dish embeddings to identify menu items that align with user taste profiles, dietary requirements, and ingredient preferences captured during the user preference collection process.

The vector similarity matching system may implement cosine similarity measures that calculate angular relationships between user preference vectors and dish embedding vectors to determine semantic alignment independent of vector magnitude differences. Cosine similarity calculations may normalize vector representations to unit length before computing dot products that measure directional alignment between user preferences and dish characteristics within the 256-dimensional embedding space. In some cases, the similarity matching process may utilize inner product similarity measures that account for both directional alignment and magnitude relationships between user preference vectors and dish embeddings. Inner product calculations may provide similarity scores that reflect both semantic compatibility and preference intensity levels captured in user preference data and dish characteristic representations.

The similarity matching algorithms may process user preference vectors against thousands of dish embeddings remaining after multi-stage filtering to identify dishes with highest semantic similarity to user taste profiles. The matching process may execute k-nearest neighbor searches that return ranked lists of dishes ordered by similarity scores calculated through mathematical distance measures between user preference vectors and stored dish embeddings. The similarity calculations may account for ingredient preference alignments, dietary restriction compatibility, and culinary relationship patterns encoded within the vector representations during the embedding generation process. The vector matching system may support configurable similarity thresholds that determine minimum compatibility requirements for dish inclusion in recommendation results, enabling the system to maintain recommendation quality standards while accommodating varying levels of user preference specificity.

The ranking system may combine vector similarity scores with contextual factors including geographic proximity and restaurant availability to generate comprehensive recommendation rankings that balance taste matching against practical dining considerations. Geographic proximity weighting may adjust similarity scores based on distance calculations between user locations and restaurant coordinates, applying configurable weighting parameters that reflect user preferences regarding travel convenience versus flavor matching priorities. Restaurant availability factors may incorporate real-time operational status including current hours, temporary closures, estimated wait times, and seating capacity to ensure recommended establishments can accommodate user dining requirements. The ranking algorithms may also process price range compatibility, service type availability, and dining environment characteristics that influence restaurant suitability for specific user contexts and dining scenarios.

The food recommendation engine 150 may implement configurable weighting parameters that enable dynamic adjustment of ranking factors based on user preferences and situational requirements during recommendation generation. Flavor matching scores derived from vector similarity calculations may receive primary weighting when users prioritize taste compatibility over convenience factors, while geographic proximity scores may receive enhanced weighting when users emphasize local dining options or time-constrained dining scenarios. The weighting system may support user-specified parameter adjustments that modify the relative importance of similarity scores, distance factors, availability considerations, and price range constraints based on individual user priorities and contextual dining needs. The configurable weighting approach may enable the recommendation engine to adapt ranking algorithms to different user personas and dining situations while maintaining consistent similarity matching accuracy across diverse recommendation scenarios.

The ranking process may incorporate temporal factors that account for restaurant operational schedules, peak dining periods, and seasonal menu availability when calculating final recommendation scores. Time-based weighting adjustments may prioritize restaurants with immediate availability during user query times while applying reduced weighting to establishments with limited hours or high demand periods that could result in extended wait times. The ranking system may also process user dining timeline preferences that influence the relative importance of immediate availability versus optimal taste matching when generating recommendation priorities. In some cases, the ranking algorithms may implement predictive availability modeling that estimates restaurant capacity and wait times based on historical patterns, current demand indicators, and real-time operational data received through restaurant management system integrations.

The food recommendation/retrieval engine 159 retrieves 460 menus and food items within menus. Embodiments may limit the menu data retrieval to within a user defined (or default) radius of the user's location. Geographic location information may be captured through device location services, manual location entry, or area-of-interest selection that enables the system to identify relevant restaurants and food establishments within specified proximity ranges. The geographic data collection process may support both current location tracking for immediate dining recommendations and destination-based location specification for planned dining experiences at specific venues or geographic areas.

The food recommendation engine 150 may generate final recommendation rankings through weighted combination algorithms that merge vector similarity scores with normalized contextual factor scores to produce comprehensive recommendation priorities. The recommendation rankings may be displayed 470 in the UI of a device 140. The combination process may apply mathematical weighting functions that balance multiple ranking factors while maintaining score interpretability and recommendation consistency across different user queries and geographic regions. Normalized scoring approaches may ensure that similarity scores, distance measurements, availability indicators, and price factors contribute proportionally to final rankings regardless of scale differences between different measurement types. The ranking system may also implement score calibration mechanisms that adjust weighting parameters based on recommendation performance feedback and user selection patterns to improve ranking accuracy over time. In some cases, the user preference data may include temporal constraints such as preferred dining times, meal type preferences, or availability windows that influence recommendation timing and restaurant selection. The system may also capture contextual preferences including price range limitations, dining environment preferences, group size considerations, and service type requirements that affect restaurant and dish suitability for specific dining scenarios.

The ranked recommendation results may include similarity score transparency that enables users to understand the basis for recommendation rankings and adjust weighting preferences for future queries. Similarity score reporting may provide numerical indicators that reflect the degree of taste compatibility between user preferences and recommended dishes based on vector matching calculations. Geographic proximity indicators may display distance measurements and estimated travel times that inform user decision-making regarding restaurant selection and dining logistics. The recommendation engine may also provide availability confidence scores that indicate the reliability of restaurant operational status and capacity information used during ranking calculations, enabling users to make informed decisions about restaurant selection based on current operational conditions and expected service quality.

### Data Storage

The database system (which may be part of data sources 112) may store vector embeddings generated from structured dish profiles in searchable data structures configured for real-time similarity matching operations across large datasets of restaurant menu information. The database system may implement OpenSearch infrastructure that provides distributed search and analytics capabilities optimized for high-dimensional vector data storage and retrieval operations. OpenSearch infrastructure within the database system may support vector indexing capabilities that organize embeddings in data structures designed for efficient similarity search operations across millions of dish profiles. The database system may maintain vector embeddings alongside associated dish metadata including restaurant information, pricing data, availability status, and structured ingredient profiles to enable comprehensive recommendation responses that include both similarity scores and contextual dish details.

The database system may utilize FAISS-powered HNSW algorithms for efficient approximate nearest neighbor searches that identify dishes with highest semantic similarity to user preference vectors. FAISS engine integration within the OpenSearch infrastructure may provide optimized vector indexing and search capabilities that support sub-second query response times across large vector datasets containing millions of dish embeddings. HNSW algorithm parameters within the database system may be configured to balance search accuracy against computational performance requirements, enabling the system to identify semantically similar dishes while maintaining real-time response capabilities for user recommendation requests. The FAISS-powered search infrastructure may support k-nearest neighbor queries that return ranked lists of dishes ordered by similarity scores calculated through mathematical distance measures between user preference vectors and stored dish embeddings.

The database system may implement vector indexing strategies that optimize storage efficiency and search performance across the high-dimensional embedding space used for dish representation. Vector indices within the database system may organize multi-dimensional embeddings (for example, 256-dimensional embeddings) using hierarchical data structures that enable efficient traversal and similarity calculation operations during recommendation queries. In some embodiments, the choice of embeddings size may contribute to a balance between dimensional richness and cost optimization/compute efficiency. In some cases, the database system may partition vector indices based on geographic regions, cuisine categories, or dietary classifications to improve search performance by reducing the search space for specific types of recommendation requests. The indexing approach may also support incremental updates that enable the database system to incorporate new dish embeddings and remove outdated menu items without requiring complete index reconstruction operations.

The database system may coordinate with real-time processing components to maintain current vector representations that reflect menu changes, seasonal offerings, and restaurant availability updates received through data source interfaces. Vector storage within the database system may support both batch processing operations for large-scale menu updates and individual vector insertions for new dish additions while maintaining search performance across concurrent user queries. The database system may also implement data consistency mechanisms that ensure vector embeddings remain synchronized with corresponding structured dish profiles and restaurant metadata throughout the recommendation processing workflow. Such consistency mechanisms may prevent recommendation errors that could occur when vector representations become misaligned with underlying dish characteristics or availability information.

In some embodiments, the food recommendation engine 150 may incorporate multimodal AI agent enhancement capabilities that extend beyond textual menu analysis to include visual and web-based data enrichment. The food recommendation engine 150 may coordinate with machine learning models to perform visual analysis of dish images when such images are available through the data source 112 or cloud network 120. In some cases, the food recommendation engine 150 may trigger web search enhancement processes when initial menu descriptions provide insufficient information for reliable classification, enabling machine learning models to retrieve additional dish information from restaurant websites and authoritative culinary sources. The food recommendation engine 150 may integrate enhanced descriptions obtained through visual analysis and web search back into the classification pipeline to improve the accuracy and completeness of structured dish profiles.

The food recommendation engine 150 may generate vector embeddings for structured dish profiles using the coordinated capabilities of multiple machine learning models within the network system 100. Vector embeddings created by the food recommendation engine 150 may represent semantic characteristics of ingredients and dish attributes in high-dimensional mathematical spaces that enable similarity calculations and matching operations. In some cases, the food recommendation engine 150 may utilize different machine learning models to generate embeddings that capture various aspects of dish characteristics, such as ingredient properties, flavor profiles, nutritional attributes, and culinary relationships. The food recommendation engine 150 may support multiple embedding model sources including text embedding models, cloud-based machine learning services, and alternative language model APIs with automatic fallback capabilities to maintain system reliability and performance.

### Software Application Embodiment

With temporary reference back to FIG. 1, a software application 134 may provide user interface capabilities that present personalized food recommendations received through the server 116 to users operating client devices 103 and user devices 140 within the network system 100. The software application 134 may implement interactive display interfaces that organize ranked recommendation results in user-friendly formats including list views, map-based presentations, and detailed dish profile displays that highlight similarity scores and matching factors. The software application 134 may coordinate with the server 116 to request and receive recommendation updates when users modify preference parameters, change geographic locations, or apply additional filtering constraints during active recommendation sessions. In some cases, the software application 134 may support real-time recommendation refresh capabilities that automatically update displayed results when restaurant availability changes or new menu items become available within the user's specified geographic area.

The software application 134 may present recommendation results through multiple visualization formats that enable users to explore ranked dishes and associated restaurant information according to different organizational schemes and display preferences. List-based recommendation displays within the software application 134 may organize dishes according to similarity scores, geographic proximity, or combined ranking factors while providing expandable detail views that reveal comprehensive ingredient profiles, dietary compatibility indicators, and allergen information. Map-based presentation modes may display restaurant locations with recommendation indicators that enable users to visualize geographic distribution of recommended establishments and assess travel requirements for different dining options. The software application 134 may also implement filtering and sorting controls that enable users to reorganize recommendation results based on specific criteria such as cuisine type, price range, distance parameters, or availability timeframes without requiring new recommendation queries through the food recommendation engine 150.

The software application 134 may facilitate user interaction with recommendation results through selection interfaces that enable users to access detailed restaurant information, view complete menu offerings, and initiate reservation or ordering processes for selected dining options. The software application 134 may coordinate with external restaurant systems and third-party services to provide integrated booking capabilities, delivery ordering interfaces, and real-time availability confirmation for recommended establishments. In some cases, the software application 134 may maintain user selection history and feedback mechanisms that capture user responses to recommendation results, enabling the system to refine future recommendations based on user behavior patterns and satisfaction indicators. The software application 134 may also support social sharing features that enable users to share recommended dishes and restaurants with other users while maintaining privacy controls over personal preference data and dietary restriction information.

The software application 134 may implement interactive recommendation exploration features that enable users to access detailed information about recommended dishes and restaurants without leaving the primary recommendation interface. Expandable detail views within the software application 134 may reveal comprehensive ingredient lists, nutritional information, preparation method descriptions, and user review summaries that provide additional context for dining decisions. Restaurant detail sections may include menu browsing capabilities, photo galleries, operational hour displays, and integrated mapping features that help users evaluate recommended establishments based on comprehensive information beyond basic recommendation scores. In some cases, the software application 134 may support comparison features that enable users to evaluate multiple recommended options side-by-side, highlighting differences in ingredient profiles, dietary compatibility, geographic proximity, and pricing factors that influence dining selection decisions.

The recommendation system 100 may coordinate with external services and restaurant management systems to provide real-time availability confirmation and integrated booking capabilities through the software application 134 interface. The delivery system may access current restaurant capacity information, reservation availability, and estimated wait times to ensure recommended establishments can accommodate user dining requirements at requested times. Integration capabilities within the software application 134 may enable direct reservation booking, takeout ordering, and delivery scheduling for recommended restaurants without requiring users to navigate to separate applications or websites. The delivery system may also support notification features that alert users to availability changes, special offers, or menu updates at previously recommended restaurants, enabling ongoing engagement with recommendation results beyond initial query responses.

The recommendation output system may maintain recommendation result persistence that enables users to save, organize, and revisit recommended dishes and restaurants through the software application 134 interface across multiple usage sessions. Saved recommendation features may include personal recommendation libraries, favorite restaurant collections, and dietary preference-based recommendation categories that help users organize and access preferred dining options over time. The output system may also support recommendation sharing capabilities that enable users to send recommended dishes and restaurants to other users while maintaining privacy controls over personal preference data and dietary restriction information. In some cases, the recommendation persistence system may coordinate with the food recommendation engine 150 to provide updated similarity scores and availability information for saved recommendations when users access previously generated recommendation results, ensuring continued accuracy and relevance of stored recommendation data.

The network system may implement external API interface capabilities that enable third-party applications to access personalized food recommendation services through standardized communication protocols and data exchange mechanisms. The external API interface may provide programmatic access to the food recommendation engine processing capabilities while maintaining data isolation and client-specific configuration requirements for different types of third-party integrations. Restaurant groups, hospitality companies, sports venues, food manufacturers, and other commercial entities may utilize the external API interface to incorporate personalized food recommendation functionality into their existing applications, websites, and customer service platforms without requiring direct integration with the underlying recommendation processing infrastructure. The API interface may support multiple authentication mechanisms, rate limiting controls, and usage monitoring capabilities that enable secure and scalable access to recommendation services across diverse client applications and usage patterns.

The external API interface may implement RESTful API endpoints that provide standardized request and response formats for recommendation queries while supporting customizable parameters that accommodate different client requirements and use case scenarios. API endpoints within the external interface may accept user preference data, dietary restriction information, geographic location parameters, and client-specific menu constraints through structured JSON request formats that maintain compatibility with the internal recommendation processing workflows. The API response formats may deliver ranked recommendation results containing dish information, restaurant details, similarity scores, and contextual metadata in standardized data structures that enable consistent integration across different client applications and presentation interfaces. In some cases, the external API interface may support batch processing capabilities that enable clients to submit multiple recommendation requests simultaneously, improving efficiency for high-volume applications such as hospitality management systems or large-scale food service operations.

Client-specific menu dataset management within the external API interface may enable third-party applications to maintain isolated menu collections that reflect their specific restaurant partnerships, venue offerings, or product catalogs while leveraging the shared recommendation processing infrastructure. The API interface may provide menu data upload capabilities that allow clients to submit their menu information through standardized data formats, triggering the same data enrichment pipeline processes used for general menu data processing including ingredient extraction, dietary classification, and allergen detection. Client menu datasets may undergo vectorization and indexing processes that create isolated search spaces within the database system, enabling recommendation queries to operate exclusively within client-specific menu collections while maintaining the same similarity matching algorithms and filtering capabilities used for general recommendation processing. The menu dataset isolation approach may ensure that recommendation results remain relevant to client offerings while preventing cross-contamination between different client menu collections and maintaining competitive separation between restaurant groups and hospitality companies.

The external API interface may support configurable processing requirements that enable clients to specify custom filtering parameters, weighting preferences, and output formats that align with their specific business requirements and customer service objectives. Processing requirement customization may include geographic constraint modifications that reflect client service areas, dietary restriction emphasis adjustments that prioritize specific dietary frameworks relevant to client customer bases, and similarity threshold configurations that control recommendation selectivity based on client quality standards. The API interface may also accommodate branding customization requirements that enable clients to receive recommendation responses formatted according to their visual identity guidelines, terminology preferences, and presentation standards without modifying the underlying recommendation accuracy or processing logic. In some cases, the external API interface may support real-time parameter adjustment capabilities that enable clients to modify processing requirements dynamically based on seasonal menu changes, promotional campaigns, or evolving customer preference patterns.

Restaurant groups may utilize the external API interface to provide personalized menu recommendations across multiple restaurant locations while maintaining consistent brand identity and menu standardization requirements. The API interface may enable restaurant groups to upload standardized menu datasets that reflect their complete restaurant portfolio, with geographic filtering capabilities that automatically scope recommendations to specific restaurant locations based on user proximity and restaurant availability. Chain restaurant implementations may benefit from the ingredient glossary mapping and dietary classification processes that ensure consistent dish categorization across all restaurant locations, enabling accurate personalized recommendations regardless of regional menu variations or local preparation differences. The external API interface may also support promotional integration capabilities that enable restaurant groups to highlight seasonal offerings, limited-time menu items, or location-specific specialties within recommendation results while maintaining personalization accuracy based on user preference matching.

Hospitality companies including hotels, resorts, airports, and entertainment venues may leverage the external API interface to provide personalized dining recommendations for guests and visitors within their specific venue ecosystems. The API interface may accommodate venue-specific menu datasets that reflect the dining options available within hospitality environments, including multiple restaurant concepts, room service menus, event catering options, and retail food offerings that comprise comprehensive dining ecosystems. Hospitality implementations may utilize geographic constraint customization to limit recommendations to on-site dining options or expand recommendations to include nearby restaurant partners based on guest preferences and venue policies. The external API interface may also support guest profile integration capabilities that enable hospitality companies to incorporate guest dietary preferences, loyalty program data, and stay duration information into recommendation processing workflows, providing personalized dining suggestions that enhance guest experience and satisfaction throughout their venue visits.

Food manufacturers and consumer packaged goods companies may access recommendation capabilities through the external API interface to provide personalized product recommendations based on ingredient preferences, dietary restrictions, and nutritional requirements captured through consumer interaction platforms. The API interface may support product catalog integration that enables food manufacturers to upload product information including ingredient lists, nutritional data, dietary certifications, and allergen information for processing through the same enrichment pipeline used for restaurant menu data. Product recommendation implementations may utilize the vector similarity matching capabilities to identify consumer packaged goods that align with user taste preferences and dietary requirements, enabling personalized product discovery experiences within e-commerce platforms, mobile applications, and digital marketing campaigns. The external API interface may also accommodate retail integration requirements that connect product recommendations with inventory availability, pricing information, and purchase facilitation capabilities across different retail channels and distribution networks.

Software development kit capabilities within the external API platform may provide pre-built integration libraries and code samples that accelerate third-party application development while ensuring consistent implementation of recommendation functionality across different programming languages and development frameworks.

SDK libraries may encapsulate API communication protocols, authentication mechanisms, error handling procedures, and response parsing logic in reusable software components that reduce integration complexity for client development teams. The SDK platform may support multiple programming languages including JavaScript, Python, Java, and mobile development frameworks to accommodate diverse client application architectures and development preferences. In some cases, the SDK libraries may include caching mechanisms, retry logic, and offline capability features that enhance application reliability and user experience when accessing recommendation services through variable network conditions or high-demand scenarios.

The external API interface may implement comprehensive usage monitoring and analytics capabilities that provide clients with detailed insights into recommendation request patterns, user engagement metrics, and recommendation performance indicators within their specific applications and customer bases. Usage analytics may include request volume tracking, response time measurements, recommendation acceptance rates, and user satisfaction indicators that enable clients to optimize their integration implementations and improve customer experience outcomes. The monitoring capabilities may also provide system health indicators, error rate tracking, and capacity utilization metrics that help clients understand service reliability and plan for scaling requirements as their user bases and recommendation request volumes grow over time. In some cases, the analytics platform may support custom reporting capabilities that enable clients to generate usage reports aligned with their internal performance measurement frameworks and business intelligence requirements.

The food recommendation system 100 may operate at national scale through distributed processing architectures that handle comprehensive datasets containing over 20 million individual dishes sourced from more than 600,000 restaurant locations across the United States. The national scale implementation may encompass diverse restaurant types including independent establishments, chain restaurants, food trucks, specialty dining venues, and institutional food service locations that collectively represent the comprehensive dining landscape available to users throughout different geographic regions. The system may maintain current menu information across this extensive restaurant network through automated data collection processes that continuously update dish availability, pricing information, seasonal menu changes, and restaurant operational status to ensure recommendation accuracy across the national coverage area.

The microservices architecture may enable scalable processing capabilities that distribute computational workloads across multiple independent service components operating within cloud infrastructure environments. Individual microservices within the architecture may handle specialized processing functions including menu data ingestion, artificial intelligence-powered enrichment operations, vector generation processes, database indexing tasks, and recommendation query processing through isolated service boundaries that enable independent scaling and resource allocation. The microservices approach may support horizontal scaling strategies that add additional service instances based on processing demand patterns, geographic load distribution, and seasonal usage variations that occur across different regions and restaurant markets throughout the national coverage area.

Containerized deployment strategies may provide consistent application environments across distributed computing resources while enabling efficient resource utilization and rapid deployment capabilities for system updates and capacity expansion. Docker containers within the deployment architecture may encapsulate individual microservices with their dependencies, configuration parameters, and runtime environments in portable packages that execute consistently across different cloud infrastructure regions and availability zones. The containerized approach may support automated deployment pipelines that distribute updated service versions across the national infrastructure without service interruptions, enabling continuous system improvements and feature additions while maintaining recommendation service availability for users across all geographic regions.

Serverless computing capabilities may complement the containerized microservices architecture by providing on-demand processing resources that automatically scale based on request volumes and computational requirements without maintaining persistent server infrastructure. Lambda functions within the serverless architecture may execute specific processing tasks including user preference vectorization, similarity matching calculations, and recommendation ranking operations in response to user queries without requiring dedicated server capacity during periods of low demand. The serverless approach may optimize computational costs by allocating processing resources only when recommendation requests occur, while providing automatic scaling capabilities that handle peak demand periods during high-traffic dining times and popular dining locations across the national coverage area.

The cloud infrastructure deployment may distribute processing capabilities across multiple geographic regions to minimize response latency and provide redundancy for system reliability across the national scale implementation. Regional deployment strategies may position processing resources closer to user populations and restaurant concentrations, reducing network transmission delays and improving recommendation response times for users in different geographic areas. The distributed infrastructure may also provide disaster recovery capabilities that maintain recommendation service availability when individual regions experience technical issues or capacity constraints, ensuring consistent user experience across the national coverage area regardless of local infrastructure conditions.

Database partitioning strategies may organize the 20+ million dish dataset across distributed storage systems that optimize query performance and enable efficient similarity matching operations at national scale. Geographic partitioning approaches may distribute restaurant and dish data based on regional boundaries, enabling recommendation queries to focus on relevant geographic subsets while maintaining access to the complete national dataset when users specify broader search parameters. The partitioning strategy may coordinate with the multi-stage filtering architecture to reduce query complexity by eliminating irrelevant geographic regions before executing computationally intensive vector similarity matching operations across the remaining relevant dish subsets.

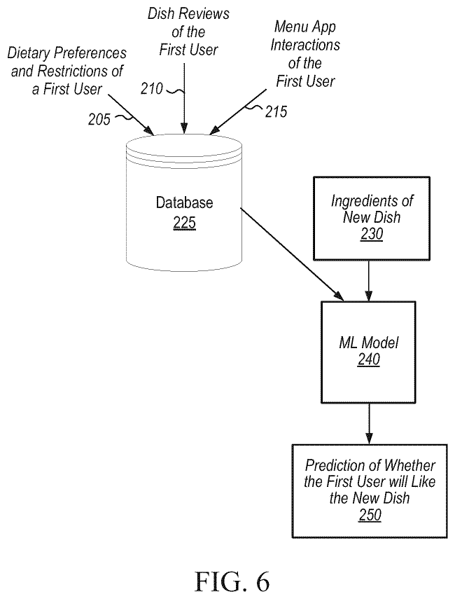

FIG. 6 illustrates a recommendation environment 200 configured to process user data and generate personalized dish predictions through machine learning analysis. The recommendation environment 200 may include various data processing components that collect, store, and analyze user-specific information to provide tailored food recommendations. Dietary preferences 205 may represent a file of stored user-specific information regarding food choices, restrictions, and preferred ingredients. The dietary preferences 205 may include data such as vegetarian or vegan preferences, allergen restrictions, spice tolerance levels, and preferred cuisine types. In some cases, the dietary preferences 205 may be collected through user onboarding processes, preference surveys within the application 134, via large language models in a conversational format, or via external applications. Dish reviews 210 may comprise a file of user-generated feedback and ratings for various food items that users have previously consumed. The dish reviews 210 may include numerical ratings, textual comments, and preference indicators that reflect user satisfaction with specific dishes. In some cases, the dish reviews 210 may provide historical data about user taste preferences and dining experiences. In some embodiments, explicitly provided feedback is used to collect real-time flavor preferences through the application 134 (for example modification of their likes and dislikes) at the time of craving at scale.

Menu application interactions 215 may be a file that captures user engagement data from interactions with food-related applications or interfaces. The menu application interactions 215 may include telemetry data such as viewing duration for specific dishes, click patterns, saved items, and browsing behavior within menu interfaces. In some cases, the menu application interactions 215 may indicate user interest levels in different types of food or dishes through behavioral analysis.

A database 225 (which may be one of the data sources 112) may store the collected user data from the recommendation environment 200. The database 225 may receive and organize the dietary preferences 205, dish reviews 210, and menu application interactions 215 in a structured format suitable for machine learning processing. In some cases, the database 225 may preprocess and pre-filter the user data from the software application 134 before storage to prepare the data for input to machine learning models. In some embodiments, the food recommendation engine 150 may leverage models to obtain data used for recommendations.

Ingredients module 230 may represent compositional data for new dishes that users have not previously tried. The ingredients module 230 may include detailed information about food components, preparation methods, and nutritional content for dishes under consideration for recommendation. In some cases, the ingredients module 230 may be preprocessed and filtered before being provided to machine learning models for analysis. Some embodiments may return many previously unseen dishes without requiring the detailed individual dish prediction process described here.

A machine learning model 240 may receive inputs from both the database 225 and the ingredients 230 to generate personalized predictions. The machine learning model 240 may function as a rule-based classifier that processes user-specific data and ingredient information to determine compatibility between users and new dishes. In some cases, the machine learning model 240 may analyze patterns in the dietary preferences 205, dish reviews 210, and menu application interactions 215 to understand user taste profiles.

A prediction 250 may be generated by the machine learning model 240 based on the processed user data and ingredient information. The prediction 250 may indicate the likelihood that a user will enjoy a new dish that the user has not previously tried. In some cases, the prediction 250 may include a numerical score representing the probability of user satisfaction with the recommended dish. In some embodiments, the food recommendation model 150 generates flavor match scores that are ranked and sorted against other factors including geographic proximity, restaurant hours, availability, ambiance preferences, and other criteria. Match scores may be categorized into [e.g., high, medium, low] likelihood ranges presented to users. The likelihood ranges serve as a display mechanism to quickly communicate information to users in UI lists or map interfaces. However, this scoring process occurs through vector similarity matching rather than the individual dish prediction methodology described in the paragraph. A prediction 250 may be displayed through a graphical user interface on one of the client devices 140(1) to present personalized recommendations to users.

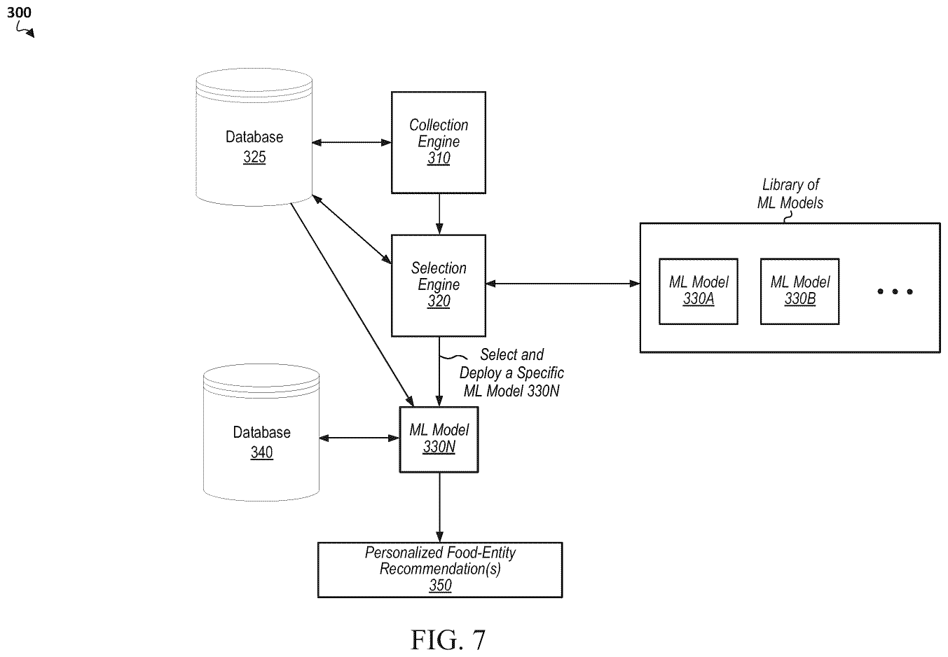

FIG. 7 illustrates a recommendation environment 300 configured to provide enhanced personalized food recommendations through dynamic model selection and data management. The recommendation environment 300 may include multiple processing components that collect user data, manage model selection, and generate tailored food recommendations based on user characteristics and data availability.

A collection engine 310 may gather various types of user data within the recommendation environment 300. The collection engine 310 may collect user dietary restrictions, user dietary preferences, user interaction data with restaurant applications, food applications, or menu software applications, and user review data associated with reviews generated by users based on dishes sampled by the users. In some cases, the collection engine 310 may process data from multiple sources to create comprehensive user profiles for a recommendation generation.

In some embodiments there may be a selection engine 320 may determine the amount and extent of data collected for particular users based on the user data collected by the collection engine 310. The selection engine 320 may analyze the quantity and quality of available user data to make informed decisions about model selection and recommendation strategies. In some cases, the selection engine 320 may distinguish between new users with limited data and experienced users with extensive interaction histories.

A user database 325 may store the various user data collected by the collection engine 310. The user database 325 may organize and maintain user dietary restrictions, user dietary preferences, user interaction data, and user review data in a structured format suitable for machine learning processing. In some cases, the user database 325 may represent any number and type of databases configured to handle different data formats and access patterns.

The selection engine 320 may select different machine learning models based on the amount of user data collected for particular users. For example, a machine learning model 330N may be selected from multiple available models (330A, 330B . . . 330N) from a library of models based on the data analysis performed by the selection engine 320. In some cases, the selection engine 320 may select a first machine learning model 330 that may be customized for relatively new users for generating first personalized food-entity recommendations for users with limited data. The selection engine 320 may select a second machine learning model 330 that may be customized for more experienced users for generating second personalized food-entity recommendations for users with extensive data histories. The machine learning model 330 selected may be tailored for particular regions or particular types of cuisines. In some cases, different machine learning models 330 may be customized for restaurants and cuisine from specific geographic regions such as Southern California, Texas, or New England. The machine learning model 330 may be customized for different cuisine types such as American cuisine, European cuisine, or Asian cuisine. In some cases, different machine learning models 330 may be customized for microregions of cuisines with finer granularity, such as individual cities or relatively small regions within a country or state, or customized for different types of cuisine such as pizza, pasta, or barbeque.

A recipe database 340 may store meal ingredients and recipe information that may be provided as inputs to the machine learning model 330. The recipe database 340 may contain detailed ingredient compositions, preparation methods, and nutritional information for various dishes and recipes. In some cases, the recipe database 340 may be accessed by the machine learning model 330 to retrieve ingredient data for comparison with user preferences stored in the user database 325.

The selected machine learning model 330 may receive user data from the user database 325 and meal ingredients from the recipe database 340 as inputs. The machine learning model 330 may process these inputs to generate personalized food-entity recommendations as outputs based on the user data and meal ingredient inputs. In some cases, the machine learning model 330 may analyze compatibility between user preferences and available recipes to determine recommendation suitability.

Personalized recommendations 350 may be generated by the machine learning model 330 and presented to users through graphical user interfaces on user computing devices. The personalized recommendations 350 may include restaurant recommendations, recipe recommendations, personalized dish recommendations, or food-related short video recommendations. In some cases, the personalized recommendations 350 may include videos, reels, images, and data that may be presented in graphical user interfaces on the client device 140. The personalized recommendations 350 may include a filtered and ranked list of dishes that users may be predicted to enjoy based on the analysis performed by the machine learning model 330.

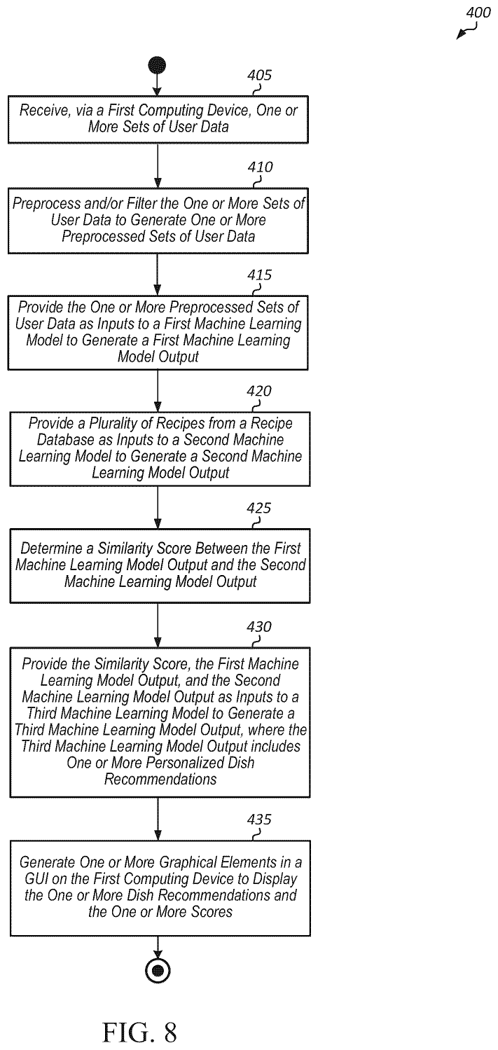

FIG. 8 illustrates a method 400 configured to generate personalized food recommendations through sequential processing of user data and recipe information using multiple machine learning models. The method 400 may include a series of steps that collect user information, process recipe data, and generate personalized recommendations for display to users.

In block 405 one or more sets of user data associated with a first user are received via the client device 140. The step may collect various types of user information including dietary restrictions, dietary preferences, user interactions, and user-generated reviews of food items with the application 134. In some cases, the step may gather user data through onboarding processes, preference surveys, or behavioral tracking within food-related applications.

In block 410 the one or more sets of user data associated with the user may be pre-processed to generate one or more preprocessed sets of user data. The 410 may perform data cleaning, formatting, and validation operations to prepare the user data for machine learning processing. In some cases, the step may filter incomplete data entries, standardize data formats, and organize user preferences into structured categories suitable for analysis by the machine learning models 135 (or any other machine learning model described above).

In block 415 the one or more preprocessed sets of user data as inputs may be provided to a first machine learning model to generate a first machine learning model output. The step may utilize a rule-based classifier that processes user dietary restrictions, preferences, and historical interactions to generate user preference scores. In some cases, the step may analyze user data patterns to create numerical representations of user taste profiles and dietary requirements.

In block 420 a plurality of recipes from the recipe database 340 may be provided to a second machine learning model to generate a second machine learning model output. The step may utilize a text-to-embedding model that converts recipe ingredient information into numerical vector representations. In some cases, the step may process recipe data to extract ingredient compositions, preparation methods, and nutritional information for comparison with user preferences.

In block 425 a similarity score between the first machine learning model output and the second machine learning model output may be determined. The step may calculate cosine similarity between the user preference vectors generated in block 415 and the recipe embedding vectors generated in block 420. In some cases, the step may measure the compatibility between user taste profiles and available recipe options through mathematical similarity calculations.

In block 430 the similarity score, the first machine learning model output, and the second machine learning model output may be provided as inputs to a third machine learning model to generate third machine learning model outputs. For example, the step may process the combined inputs to generate personalized dish (a particular variety or preparation of food served as part of a meal) recommendations and corresponding scores for the recommendations. In some cases, the step may utilize a ledger system to track score adjustments when calculating food match scores, recording bonuses for preferred ingredients and penalties for restricted or avoided items. The step may normalize dish scores to a range between 68 and 98 to provide consistent scoring across different food items and user profiles.

In block 435 one or more graphical elements may be generated in a graphical user interface on the client device 140(1) to display the one or more personalized food recommendations and may include the one or more scores. The step may create visual representations of recommended dishes, restaurants, or recipes along with their corresponding compatibility scores. In some cases, the step may organize the personalized recommendations 350 in ranked order based on the normalized scores and present the recommendations through interactive interface elements that allow users to view detailed information, place orders, or provide feedback on suggested items.

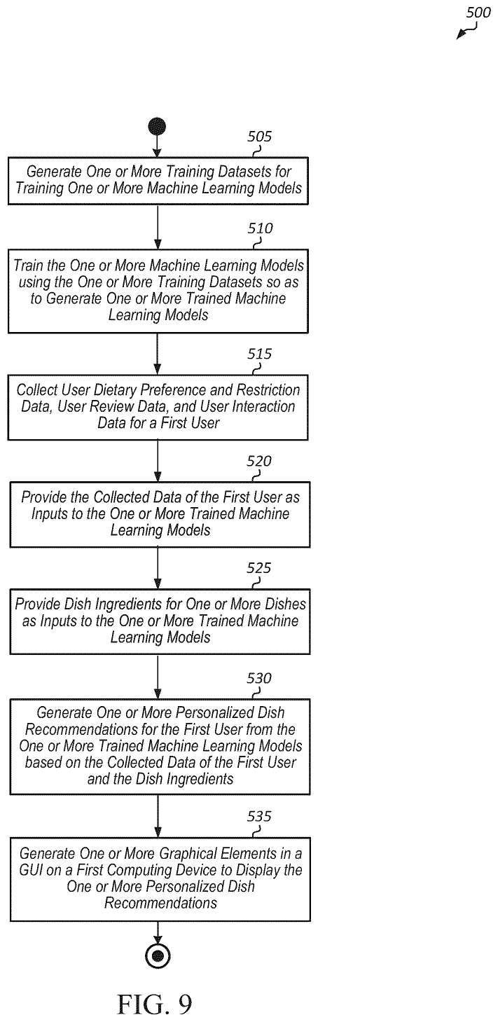

FIG. 9 illustrates a method 500 to train machine learning models for generating personalized food recommendations through systematic data collection, model training, and validation processes. The method 500 may include a series of steps that prepare training data, develop machine learning capabilities, and validate recommendation accuracy through user interaction analysis.

In block 505, one or more training datasets may be generated for training one or more machine learning models. The step may compile various types of data including user dietary restrictions and preferences, user likes and dislikes of menu items, user reviews written of menu items, user interaction data with various restaurant applications, food-related applications, and food-ordering applications, and dish ingredients for various dishes from a plurality of restaurants. In some cases, the step may incorporate user behavior data and telemetry data related to application usage to infer user preferences based on viewing patterns, click behaviors, and saved item selections. The step may preprocess and filter the collected data prior to incorporation in the training datasets to ensure data quality and consistency for machine learning processing.

In block 510, the one or more machine learning models may be trained using the one or more training datasets generated in block 505 to generate one or more trained machine learning models. The step may utilize various machine learning techniques including neural networks, recurrent neural networks, convolutional neural networks, generative models, or transformer-based architectures to develop recommendation capabilities. In some cases, the step may employ hyperparameter optimization through grid search methods to identify optimal model configurations, including variations in epochs, batch sizes, and learning rate multipliers for different model types.

In block 515, user dietary preference and restriction data, user review data, and user interaction data may be collected for a user of the system after the training process completed in block 510. The step may gather real-time user information through the application 134, capturing user preferences through onboarding surveys, behavioral tracking, and explicit feedback mechanisms. In some cases, the step may classify the user dietary preference and restriction data into various dietary restriction categories based on allergens to facilitate more precise matching with available food options.

In block 520, the collected data of the first user from block 515 may be provided as inputs to the one or more trained machine learning models generated in block 510. The step may format and structure the user data to match the input requirements of the trained models, ensuring compatibility between the collected user information and the model processing capabilities. In some cases, the step may convert user preference data into numerical vector representations suitable for mathematical processing by the machine learning models 135.

In block 525, dish ingredients for one or more dishes may be provided as inputs to the one or more trained machine learning models along with the user data from block 520. The step may retrieve ingredient information from the recipe database 340 and preprocess the dish ingredients prior to providing the ingredients as inputs to the trained machine learning models. In some cases, the step may convert the dish ingredients for each dish into vector representations with numerical elements to enable mathematical comparison with user preference vectors. The step may enrich food-related data to fill in missing ingredients and classify the food-related data with allergen and dietary restriction categories to match user preferences and user restrictions.

In block 530, one or more personalized food-entity recommendations may be generated for the user based on the collected data of the user and the dish ingredients processed by the one or more trained machine learning models. The step may produce various types of recommendations including restaurant recommendations, recipe recommendations, personalized dish recommendations, or food-related short video recommendations depending on the specific model configuration and user context. In some cases, the step 530 may calculate compatibility scores between user preferences and available food options, utilizing cosine similarity calculations and rule-based scoring systems to rank potential recommendations. Depending on the embodiment, the one or more food recommendations may include a restaurant recommendation, recipe recommendation, personalized dish recommendations, food-related short video recommendations, or other types of recommendations.

In block 535, one or more graphical elements in a graphical user interface may be generated on the client device 140 to display the one or more personalized food recommendations generated in block 530 to the first user. The step may create visual presentations of recommended items including images, videos, textual descriptions, and interactive elements that allow users to explore recommendation details, place orders, or provide feedback. In some cases, the step may organize the personalized recommendations 350 in ranked order based on calculated compatibility scores and present the recommendations through interface elements that facilitate user engagement and interaction with the recommended food options.

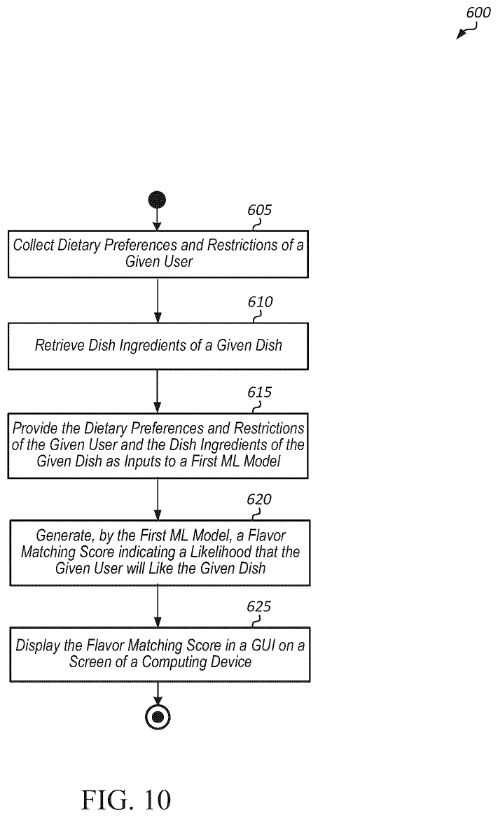

FIG. 10 illustrates a process 600 to generate flavor matching scores that indicate the likelihood of user satisfaction with specific dishes through systematic analysis of user preferences and dish compositions. The process 600 may include a series of steps that collect user dietary information, retrieve ingredient data, and calculate compatibility scores for presentation to users through graphical interfaces.

In block 605, dietary preferences and restrictions of a given user may be collected by the application 134. The step may gather user-specific information including allergen restrictions, dietary limitations such as vegetarian or vegan preferences, ingredient preferences, and food avoidance patterns. In some cases, the step may collect the dietary preferences and restrictions through user onboarding surveys, preference settings within the application 134, or behavioral analysis of user interactions with food-related content. The step may organize the collected dietary information into structured categories suitable for processing by the machine learning models 138. for processing by the machine learning models 135.

In block 610, dish ingredients of a given dish may be retrieved by the application 134 based on the collection of user preferences in block 605. The step may access ingredient information from the recipe database 340 or other data sources to obtain detailed compositional data for dishes under consideration for recommendation. In some cases, the step may retrieve ingredient lists, preparation methods, nutritional information, and allergen data associated with specific dishes. The step may preprocess the retrieved ingredient data to ensure compatibility with machine learning model input requirements.

In block 615, the dietary preferences and restrictions of the given user and the dish ingredients of the given dish may be provided as inputs to a machine learning model. The step may format the user preference data and ingredient information into numerical representations suitable for mathematical processing by the machine learning model. In some cases, the step may convert categorical dietary restrictions into binary indicators and transform ingredient lists into vector embeddings that capture ingredient relationships and nutritional properties. The step may ensure that the input data maintains consistency with the training data formats used during model development.

In block 620, a flavor matching score may be generated indicating a likelihood that the given user will like the given dish through processing by the machine learning model. The step may calculate compatibility between user preferences and dish characteristics using mathematical similarity measures and rule-based scoring algorithms.

In some cases, the step may perform intermediary steps of vector embedding generation and cosine similarity search to determine the flavor matching score. The step may apply scoring adjustments based on user dietary restrictions, ingredient preferences, and historical interaction patterns to produce a numerical score representing the probability of user satisfaction with the dish.

In block 625, the flavor matching score may be displayed in a graphical user interface on a screen of the client device 140 through the application 134. The step may present the flavor matching score along with dish information, ingredient details, and recommendation context to facilitate user decision-making. In some cases, the step may display a list of dishes including the given dish ranked and sorted based on their flavor matching scores within the graphical user interface. The step may provide interactive elements that allow users to explore dish details, view ingredient compositions, and access additional information about recommended food options based on the calculated flavor matching scores. Additional interactive elements may include a map, a find food feature, and other search elements.

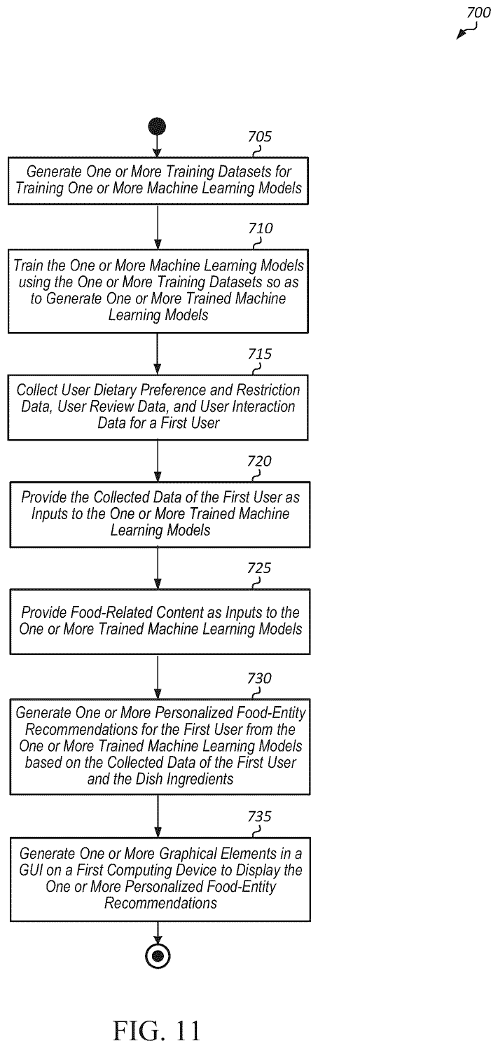

FIG. 11 illustrates a process 700 to train machine learning models for generating personalized food recommendations. In block 705 one or more training datasets may be generated for training one or more machine learning models.

In block 710, the one or more machine learning models may be trained using the one or more training datasets generated in the block 705. The step may utilize various machine learning architectures including neural networks, recurrent neural networks, convolutional neural networks, generative models, generative adversarial networks, generative pre-trained transformers, or diffusion models to develop recommendation capabilities. In some cases, the step may employ hyperparameter optimization through grid search methods to identify optimal model configurations, including variations in epochs, batch sizes, and learning rate multipliers for different model types. The step may implement automated model tuning processes that create fine-tuning jobs and identify optimal model configurations through systematic evaluation of performance metrics. The step may utilize cloud-based training infrastructure to support scalable model development and validation processes.

In block 715, user dietary preference and restriction data, user review data, and user interaction data may be collected for a user after the training process completed in the block 710. The step may gather real-time user information through the application 134, capturing user preferences through onboarding surveys, behavioral tracking, and explicit feedback mechanisms. In some cases, the step may classify the user dietary preference and restriction data into various dietary restriction categories based on allergens to facilitate more precise matching with available food options. The step may collect user interaction data, from for example, multimedia content, including telemetry information about user engagement with video content, images, and textual descriptions of food items to understand user interest patterns and preference indicators.

In block 720, the collected data of the user from block 715 may be provided as inputs to the one or more trained machine learning models trained in block 710. The step may format and structure the user data to match the input requirements of the trained models, ensuring compatibility between the collected user information and the model processing capabilities. In some cases, the step may convert user preference data into numerical vector representations suitable for mathematical processing by the machine learning models. The step may organize user dietary restrictions, preferences, and interaction patterns into structured data formats that enable efficient processing by the trained machine learning models.

In block 725, food-related content may be provided as inputs to the one or more trained machine learning models along with the user data from block 720. The step may retrieve food-related content including dish ingredients for one or more dishes, restaurant menus and reviews, and food-related videos from the recipe database 340 and other data sources. In some cases, the step may enrich the food-related content data to fill in missing ingredients and enhance data completeness for more accurate recommendation generation. The step may preprocess the food-related content prior to providing the content as inputs to the trained machine learning models, including conversion of various types of food-related content into vector representations with numerical elements. The step may classify food-related content based on dietary attributes including allergen information, dietary restriction categories, and nutritional properties to facilitate matching with user preferences and restrictions.

In block 730, one or more personalized food recommendations may be generated for the user based on the collected data of the first user and the food-related content processed by the one or more trained machine learning models. The step may produce various types of recommendations including restaurant recommendations, recipe recommendations, personalized dish recommendations, or food-related short video recommendations depending on the specific model configuration and user context. In some cases, the step may calculate compatibility scores between user preferences and available food options, utilizing cosine similarity calculations and rule-based scoring systems to rank potential recommendations. The step may apply normalization processes to ensure recommendation scores fall within consistent ranges and provide meaningful comparisons between different food options.

In block 735, one or more graphical elements may be generated in a graphical user interface on the client device 140 to display the one or more personalized food recommendations generated in block 730 to the user. The step may create visual presentations of recommended items including videos, images, and textual data that facilitate user exploration of recommendation details and food option characteristics. In some cases, the step may organize the personalized recommendations 350 in ranked order based on calculated compatibility scores and present the recommendations through interactive interface elements that enable user engagement with recommended food options. The step may provide interface functionality that allows users to access detailed information about recommended dishes, restaurants, or recipes, and facilitate user feedback collection for continuous improvement of recommendation accuracy.

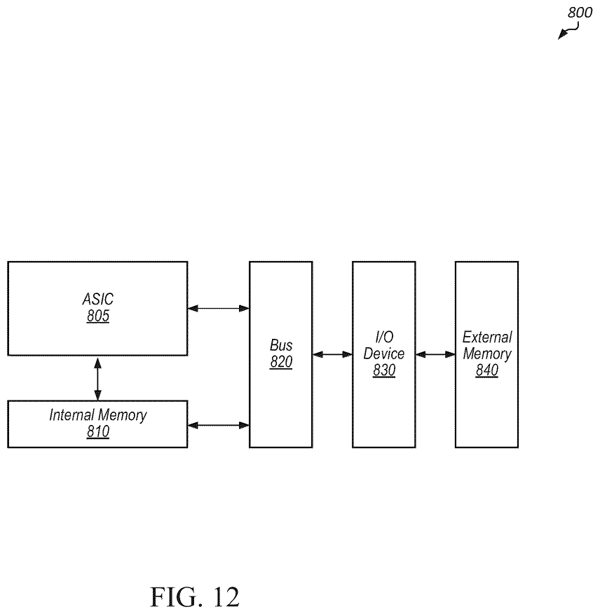

FIG. 12 illustrates a computing system 800 configured to implement machine learning models for food recommendation processing through specialized hardware components and interconnected processing elements. The computing system 800 may provide the computational infrastructure for executing the machine learning models 138 within the cloud platform 130 to generate personalized food recommendations for users.

An application specific integrated circuit 805 may be configured to implement one or more machine learning models in accordance with the food recommendation processing described herein. The application specific integrated circuit 805 may represent any type of circuit or processing unit for implementing the machine learning models 138 used in the recommendation environment 200 and the recommendation environment 300. In some cases, a graphics processing unit, a tensor processing unit, or another type of processing unit or circuit may be used in place of or in addition to the application specific integrated circuit 805 to provide computational capabilities for machine learning processing.

The application specific integrated circuit 805 may include a plurality of neurons organized in a plurality of layers with neurons from one layer connected to neurons from a subsequent layer optionally with logic circuits for altering, adjusting, and applying mathematical functions to the values of the neurons before connecting to the subsequent layer. In some cases, the plurality of neurons may be organized in an array where each neuron comprises a register, an input connection, and an output connection. The application specific integrated circuit 805 may process user data from the user database 325 and recipe information from the recipe database 340 to generate the personalized recommendations 350 through neural network computations.

An internal memory 810 may be coupled to the application specific integrated circuit 805 for storing input and output values during machine learning processing operations. The internal memory 810 may provide high-speed data access capabilities for the application specific integrated circuit 805 during the execution of machine learning algorithms. In some cases, the internal memory 810 may store intermediate computational results, user preference vectors, recipe embeddings, and similarity scores generated during the processing steps described in the method 400, the method 500, the process 600, and the process 700.

A bus 820 may be coupled to both the application specific integrated circuit 805 and the internal memory 810 to facilitate data communication between the processing components of the computing system 800. The bus 820 may provide data pathways for transferring information between different hardware components within the computing system 800. In some cases, the bus 820 may enable the transfer of user data, recipe information, and machine learning model parameters between the various processing and storage elements.

An input output device 830 may be coupled to the bus 820 to provide communication capabilities between the computing system 800 and external systems or components. The input output device 830 may facilitate data exchange with the client device 140(1) and the database 112 through the network 110. In some cases, the input output device 830 may receive user preference data collected by the collection engine 310 and transmit the personalized recommendations 350 generated by the machine learning models 135 to client devices for display through the application 134.

An external memory 840 may be coupled to the input output device 830 to provide additional storage capacity for the computing system 800. The external memory 840 may have a larger capacity than the internal memory 810 to accommodate extensive datasets including user profiles, recipe databases, and machine learning model parameters. In some cases, the external memory 840 may have a slower access capability as compared to the internal memory 810 which may be accessed with a relatively higher data rate. The external memory 840 may store training datasets used in the step 505 and the step 705, historical user interaction data, and comprehensive recipe information that supports the recommendation generation processes described in the method 400, the method 500, the process 600, and the process 700.

The computing system 800 may be incorporated within the cloud platform 130 or as part of an organization's local computing environment on one or more servers to provide the computational infrastructure for the machine learning models 138. In some cases, the computing system 800 may support the processing requirements for analyzing the dietary preferences 205, the dish reviews 210, and the menu application interactions 215 to generate the prediction 250 through the machine learning model 240. The computing system 800 may enable the selection engine 320 to choose appropriate machine learning models based on user data availability and facilitate the generation of personalized recommendations 350 through coordinated operation of the hardware components.

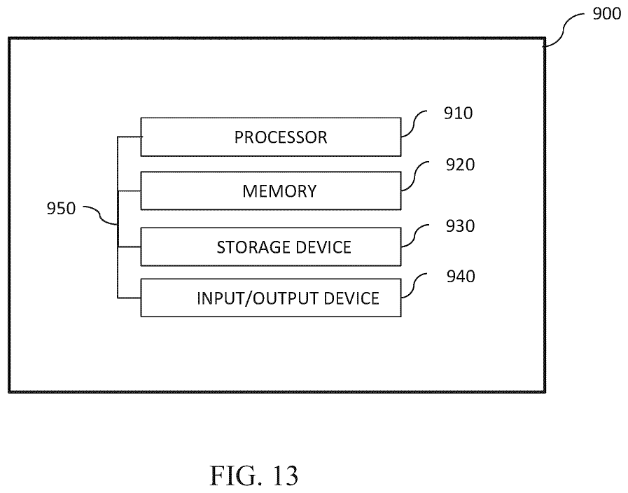

FIG. 13 illustrates a computing system 900 configured to provide general-purpose computational infrastructure that may support the implementation of food recommendation systems through standard computing components and interconnected processing elements. The computing system 900 may represent a conventional computing architecture that may be utilized to execute the machine learning models 138, host the application 134, or provide processing capabilities for the cloud platform 130.

A processor 910 may be configured to process instructions for execution within the computing system 900. The processor 910 may handle computational tasks associated with user data processing, machine learning model execution, and recommendation generation within the food recommendation system. In some cases, the processor 910 may be a single-threaded processor that executes instructions sequentially. The processor 910 may be a multi-threaded processor that may execute multiple instruction streams concurrently to improve processing efficiency for complex machine learning operations. The processor 910 may be configured to process instructions stored in the memory 920 or on the storage device 930, including receiving or sending information through the input output device 940. The processor 910 may execute the collection engine 310 operations for gathering user dietary preferences and restrictions, process the selection engine 320 logic for determining appropriate machine learning models, and perform the computational operations described in the method 400, the method 500, the process 600, and the process 700.

A memory 920 may store information within the computing system 900 to support processing operations performed by the processor 910. The memory 920 may provide temporary storage for user preference data collected from the first client device 140(1) during recommendation generation processes. In some cases, the memory 920 may be a computer-readable medium that stores program instructions and data structures used by the processor 910. The memory 920 may be a volatile memory unit that provides high-speed access to frequently used data during machine learning processing operations. In some cases, the memory 920 may be a non-volatile memory unit that retains stored information when power may be removed from the computing system 900. The memory 920 may store intermediate results from the machine learning model 240 processing, user preference vectors generated by the collection engine 310, and recipe embeddings retrieved from the recipe database 340.

A storage device 930 may be capable of providing mass storage for the computing system 900 to accommodate large datasets and persistent information storage requirements. The storage device 930 may store comprehensive user profiles maintained in the user database 325, extensive recipe information from the recipe database 340, and historical interaction data used for training the machine learning models 138. In some cases, the storage device 930 may be a computer-readable medium that provides long-term data retention capabilities. The storage device 930 may be a floppy disk device, a hard disk device, an optical disk device, a tape device, non-volatile solid state memory, or any other type of storage device suitable for maintaining large volumes of food recommendation data. The storage device 930 may store training datasets used in the step 505 and the step 705, machine learning model parameters, and comprehensive databases of user preferences and recipe information that support the recommendation generation processes.

An input output device 940 may be configured to provide input and output operations for the computing system 900 to facilitate communication with external systems and user interfaces. The input output device 940 may handle data exchange between the computing system 900 and the network 110 to receive user data from client devices and transmit the personalized recommendations 350 to users through the application 134. In some cases, the input output device 940 may include a keyboard and pointing device for direct user interaction with the computing system 900. The input output device 940 may include a display unit for displaying graphical user interfaces that present food recommendations, user preference settings, and system administration interfaces. The input output device 940 may facilitate the collection of the dietary preferences 205, the dish reviews 210, and the menu application interactions 215 from user devices and enable the presentation of the prediction 250 and the personalized recommendations 350 through various interface modalities.

A system bus 950 may interconnect the processor 910, the memory 920, the storage device 930, and the input output device 940 to enable coordinated operation of the computing components within the computing system 900. The system bus 950 may provide data pathways for transferring user preference information, recipe data, machine learning model parameters, and recommendation results between the various hardware components. In some cases, the system bus 950 may facilitate the transfer of preprocessed user data from the step 410 to the processor 910 for machine learning processing, the movement of recipe information from the storage device 930 to the memory 920 for analysis, and the communication of generated recommendations from the processor 910 to the input output device 940 for transmission to client devices. The system bus 950 may enable the computing system 900 to support the computational requirements for executing the selection engine 320 operations, processing the machine learning model 240 calculations, and coordinating the data flow described in the recommendation environment 200 and the recommendation environment 300.

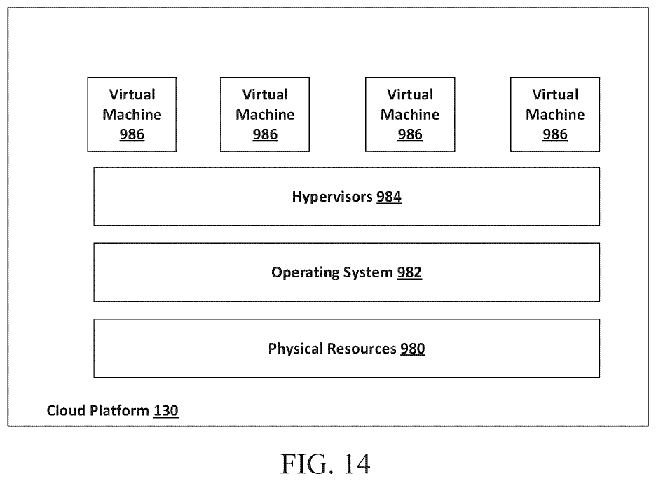

FIG. 14 illustrates the cloud platform 130 configured to provide virtualized computing infrastructure that enables scalable deployment of the food recommendation system across distributed computing resources. The cloud platform 130 may implement a layered architecture that abstracts physical hardware resources through virtualization technologies to support multiple concurrent instances of the machine learning models 138 and the application 134.

Physical resources 980 may form the foundational hardware layer of the cloud platform 130. The physical resources 980 may include one or more hardware servers, storage systems, memory modules, and network interfaces that provide the computational and data storage capabilities for the food recommendation system. In some cases, the physical resources 980 may comprise multiple server nodes distributed across different geographic locations to provide redundancy and performance optimization for users accessing the system through the first client device 140(1).

An operating system 992 may be implemented on the physical resources 980 to provide basic system management and resource allocation capabilities for the cloud platform 130. The operating system 992 may manage hardware resource access, process scheduling, and system-level operations that support the virtualized environment. In some cases, the operating system 992 may coordinate resource allocation between different components of the food recommendation system and facilitate communication between the virtualized layers and the underlying physical resources 980.

A hypervisor 984 may be implemented above the operating system 982 to create and manage virtualized computing environments within the cloud platform 130. The hypervisor 984 may abstract the physical resources 980 to enable multiple isolated computing instances to operate concurrently on the same hardware infrastructure. In some cases, the hypervisor 984 may allocate processor time, memory resources, and storage capacity to different virtual environments based on the computational requirements of the machine learning models 138 and the application 134. The hypervisor 984 may provide resource isolation between different virtual instances to ensure that processing operations for one user or application do not interfere with operations for other users or applications.

Multiple virtual machine 986 instances may be created and managed by the hypervisor 984 to provide isolated computing environments for different components of the food recommendation system. Each virtual machine 986 may operate as an independent computing instance with allocated portions of the physical resources 980 including processor capacity, memory allocation, and storage space. In some cases, different virtual machine 986 instances may host different aspects of the recommendation system, such as one virtual machine 986 running the collection engine 310 for user data gathering, another virtual machine 986 executing the machine learning model 240 for recommendation generation, and additional virtual machine 986 instances managing the user database 325 and the recipe database 340.

The virtualized architecture provided by the cloud platform 130 may enable scalable deployment of the food recommendation system through dynamic resource allocation and load distribution. In some cases, the hypervisor 984 may create additional virtual machine 996 instances during periods of high user demand to maintain system performance and responsiveness. The cloud platform 130 may automatically scale the number of virtual machine 996 instances based on the volume of user requests received through the network 110 and the computational requirements for processing the dietary preferences 205, the dish reviews 210, and the menu application interactions 215.

The cloud platform 130 may implement a CI/CD pipeline for automating deployment of the machine learning models 138 and containerized applications across the virtual machine 996 instances. The CI/CD pipeline may facilitate continuous integration and deployment processes that enable rapid updates to the recommendation algorithms, user interface components, and system configurations without disrupting ongoing operations. In some cases, the CI/CD pipeline may automatically deploy updated versions of the machine learning models to appropriate virtual machine 986 instances and coordinate the rollout of new features or improvements to the application 134.

The cloud platform 130 may utilize AWS Step Functions for workflow orchestration instead of traditional workflow management systems to coordinate complex processing sequences across the virtual machine 986 instances. AWS Step Functions may provide state machine-based orchestration that manages the execution flow of data processing operations, machine learning model training, and recommendation generation processes. In some cases, AWS Step Functions may coordinate the sequence of operations described in the method 400, the method 500, the process 600, and the process 700 across multiple virtual machine 986 instances, ensuring that user data flows efficiently from the collection engine 310 through the selection engine 320 to generate the personalized recommendations 350. The workflow orchestration may enable fault tolerance and error recovery mechanisms that maintain system reliability when individual virtual machine 986 instances experience processing issues or resource constraints.

### Microservices Architecture

Some embodiments use serverless Lambda functions to handle processing without VM management. An SNS provides asynchronous message queuing between services. S3 data lake storage may replace the database VMs described above. An OpenSearch managed service may be used instead of search infrastructure VMs such as the VMs described above. Auto-scaling may be handled by AWS services rather than hypervisor resource allocation.

### Example Architecture

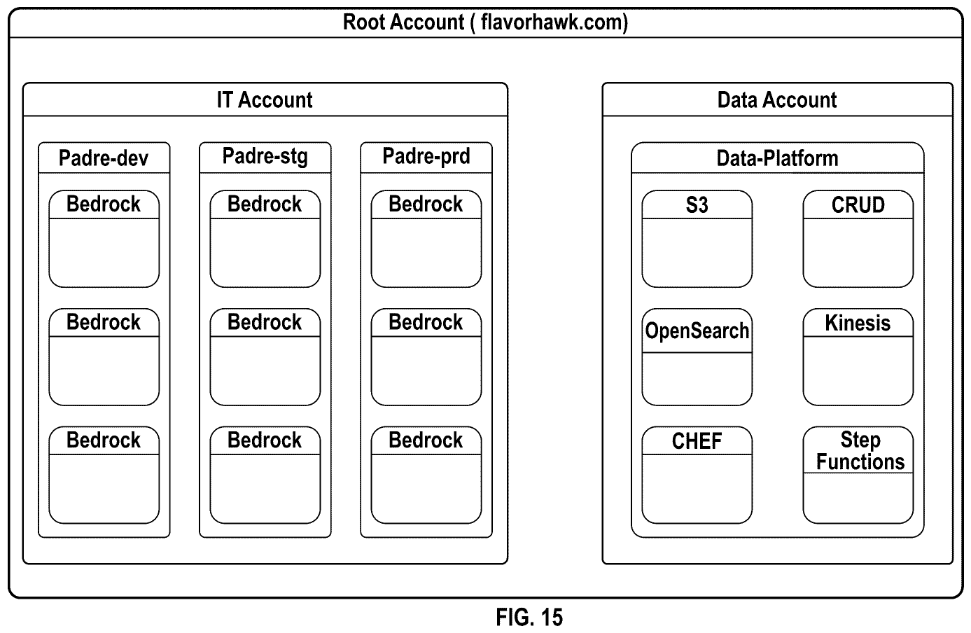

FIG. 15 shows a cloud architecture and organization structure for resources and services organized across multiple accounts and environments within the hosting platform in cloud platform 130. At the top level is the Root Account, under which there are two main sub-accounts: IT Account and Data Account. Model Provider Flexibility: The Figure shows only Bedrock service, but it will be understood that other embodiments may implement different services including for example, “AWS Bedrock, OpenAI API, or Anthropic API LLM calls” with adaptive model selection based on “cost optimization, rate limits, use case requirements.” Some embodiments may also support local models running on VMs with Ollama servers for additional flexibility.

In general, the IT account is used for application and environment-specific development. It contains three environments under a system/project named padre:
padre-dev (Development)
padre-stg (Staging)
padre-prd (Production)

Each of these environments uses Bedrock service for generative AI services.

The Data Account manages the data platform and analytics infrastructure. The single environment is called data-platform and includes:
S3 (Object storage for data)
CRUD (represents a data collection layer that encompass internal UIs and data collection infrastructure like servers and databases)
OpenSearch (Search and vector similarity engine)
Kinesis (Streaming data ingestion)
CHEF (which is the data pre-processing/enrichment layer for the dish data)

### Step Functions (Orchestration of Serverless Workflows)

The storage service S3 may be configured to provide scalable data storage capabilities that support the data architecture requirements of the food recommendation system. The storage service S3 may serve as a centralized repository for managing various types of information used by the machine learning models 135 and the application 134 within the cloud platform 130. The storage service S3 may also be configured to store and process vector embeddings directly within the datastore, enabling vector similarity operations and embedding management as an alternative to specialized vector database services, supporting both traditional data lake storage and native vector processing capabilities within unified S3 infrastructure.

The storage service S3 may store recipe data retrieved from the recipe database 340 in structured formats that facilitate efficient access by the machine learning models 135. In some cases, the storage service S3 may maintain comprehensive ingredient compositions, preparation methods, nutritional information, and allergen data for dishes from multiple restaurants and food providers. The storage service S3 may organize recipe information into hierarchical data structures that enable rapid retrieval based on cuisine types, dietary restrictions, or ingredient categories.

The storage service S3 may manage user preference data collected by the collection engine 310 from the first client device 140(1). In some cases, the storage service S3 may store the dietary preferences 205, the dish reviews 210, and the menu application interactions 215 in formats that support efficient processing by the selection engine 320. The storage service S3 may maintain user profiles that include dietary restrictions, ingredient preferences, historical ratings, and behavioral patterns captured through interactions with the application 134.

The storage service S3 may integrate with the virtual machine 996 instances within the cloud platform 130 to provide distributed access to stored data across multiple processing nodes. In some cases, the storage service S3 may enable parallel data access patterns that support concurrent processing operations performed by different virtual machine 996 instances executing various components of the recommendation environment 200 and the recommendation environment 300. The storage service S3 may implement caching mechanisms that reduce data access latency for frequently requested information such as popular recipes or common user preference patterns. The storage services S3 may include data lake storage for processed data and vector storage for embedding operations. Storage services S3 may handle enriched dish data while OpenSearch stores and indexes vector embeddings for similarity matching.

The storage service S3 may provide backup and disaster recovery capabilities for the food recommendation system data through automated replication and versioning features. In some cases, the storage service S3 may maintain multiple copies of user preference data and recipe information across different geographic regions to ensure data availability and system resilience. The storage service S3 may implement data retention policies that manage the lifecycle of stored information based on usage patterns and regulatory requirements.

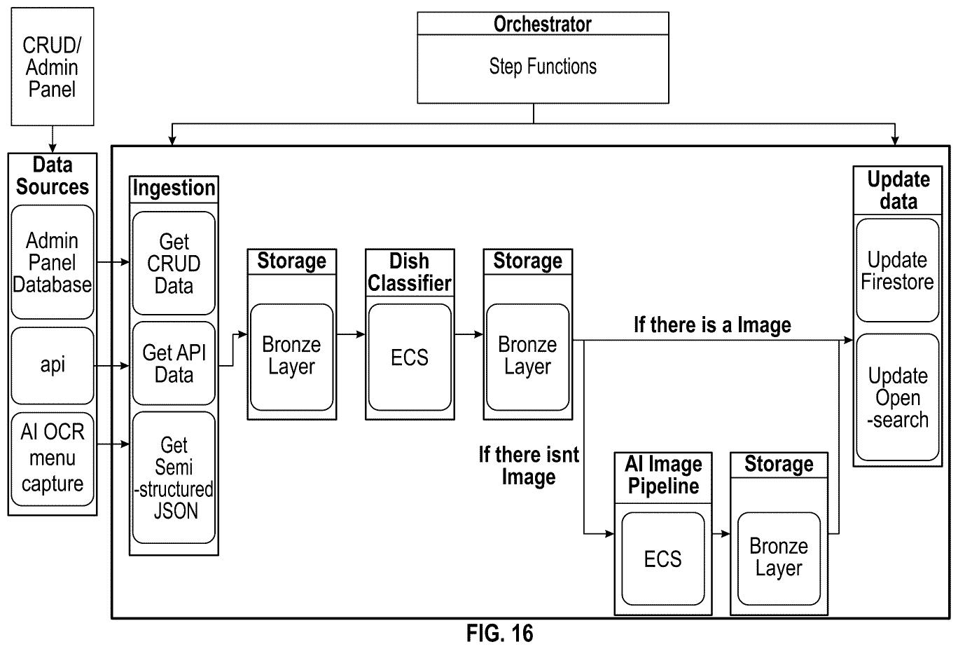

FIG. 16 shows a data pipeline that collects data from various structured/unstructured sources for use in the food recommendation system 100. Embodiments may include a menu image ingestion module, which may be configured to capture menu data dynamically from menu images, where images are passed to an LLM for optical character recognition and returned as structured text for processing through the enrichment pipeline. Sources may include for example, online or physically printed and digitized menus, textbooks (such as recipe books, nutritional reference books, diet books, etc.), social media posts, A.I.-based menu files via OCR image capture to text translation, etc. For menus captured via A.I.-based OCR image capture, an OCR module in the server 116 system processes menu images through optical character recognition and AI-powered text extraction to convert visual menu content into structured text data for the enrichment pipeline, supporting multimodal data ingestion capabilities alongside existing text-based menu sources. The collected data may be stored in any one of the aforementioned databases. The pipeline processes and classifies data using containerized services. In some embodiments, the pipeline conditionally enriches data (adds images via AI if missing). Raw data may be stored and processed into outputs. The Update data container updates search and NoSQL databases for downstream use.

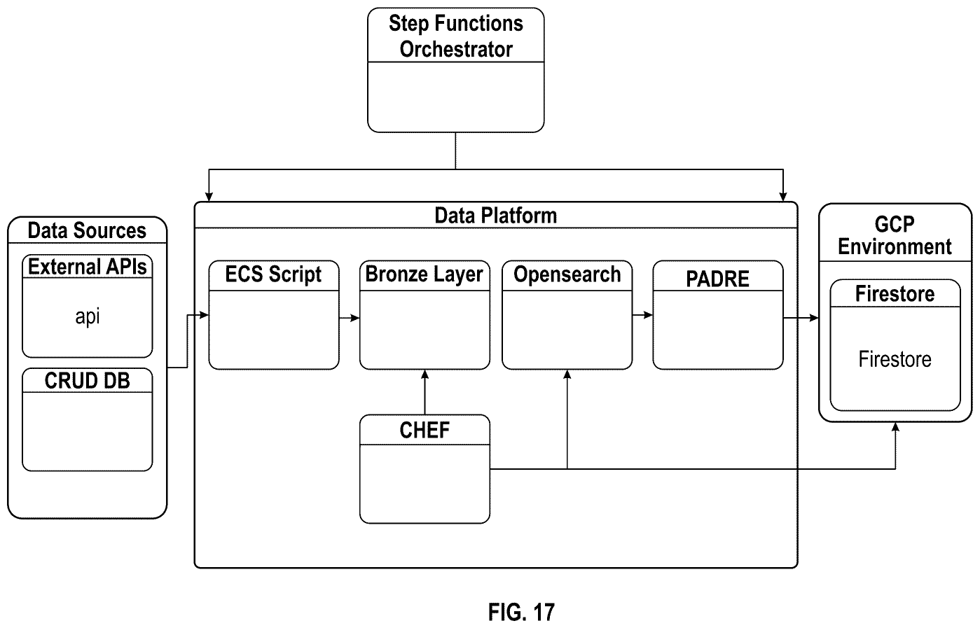

FIG. 17 shows a hybrid cloud data pipeline that may be used in some embodiments. In one implementation, one service is used for processing (for example, Amazon Web Services®) and one service is used for delivery (Google Cloud Platform®) with respect to meal or food-related data. Data is ingested from APIs and databases. the data is processed via A.I./M.L. and analytics tools. Processed data may be delivered to one service (e.g., OpenSearch®) for search functions and another service (e.g., Firestore® (GCP®)) for real-time app usage. The CRUD DB represents an Internal database storing structured application data. Within the data platform, an ECS container runs ingestion scripts that fetch data from the MealMe API and CRUD DB. This step performs transformation or normalization as needed. Within the Bronze Layer (S3), raw or minimally processed data is stored in Amazon S3. The CHEF module is an AI/ML Pipeline that applies AI models for tagging, classification, and/or enrichment (e.g., predicting dish type, cuisine, dietary info). The processed output is written back to the Bronze layer. In the OpenSearch module, enriched data is indexed into OpenSearch, enabling search and filtering capabilities across the data platform (e.g., search for meals by ingredients, dietary tags). The PADRE module represents the ML/AI modelling system of the subject technology handling further processing (e.g., predicting, ranking, personalization, and recommendations). The output from the PADRE module feeds into Firestore for consumption by GCP-hosted services or apps.

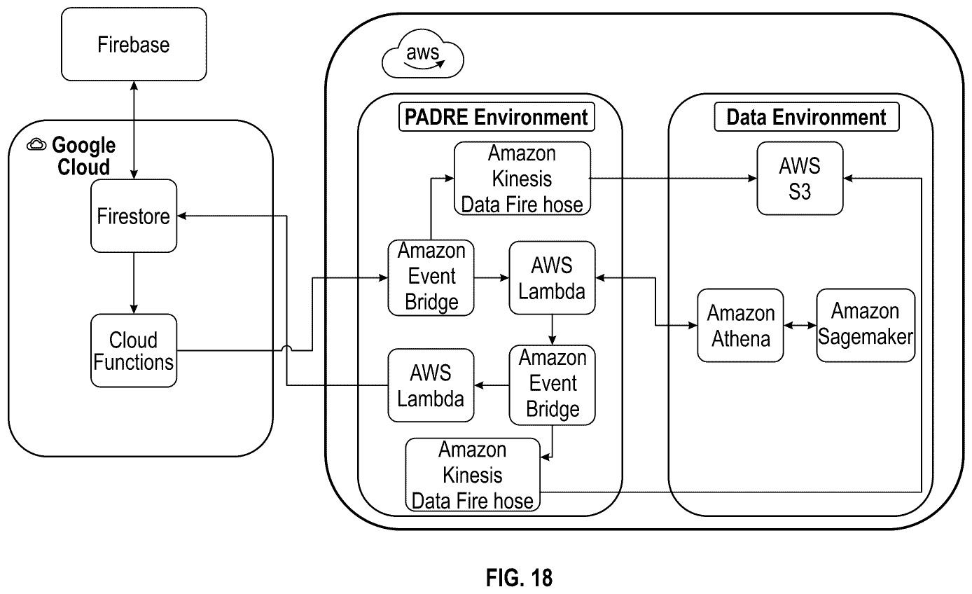

FIG. 18 diagram illustrates the integration flow between Google Cloud (Firebase/Firestore) and the AWS-based PADRE AI/ML system, showing how food-related data and preferences are collected, processed, enriched using AI, and returned to improve food recommendations. The left side of the diagram (Google Cloud) represents the front-end or user interaction layer (Firebase app, Firestore database, Cloud Functions). The right side (AWS) represents the PADRE AI/ML backend system, which processes and enriches data for personalized recommendations. There may be two distinct AWS environments: PADRE Environment, which may be responsible for orchestrating AI/ML logic; and Data Environment, which may store and index data (S3, OpenSearch) and supports model inference. In operation, the Google Cloud Side may interact with a user on the front-end via triggering input from the user. The front-end interactions may include for example, selecting food preferences and entering dietary restrictions (caloric limits, allergens, etc.) by the user into the application 134. The Firestore module stores structured food or user preference data. The Cloud Functions module may be triggered when Firestore is updated and sends relevant data to the AWS side for processing.

The PADRE Environment (AI/ML system) orchestrates the entire AI/ML workflow in an online hosting service after receiving data from the GCP side. The PADRE environment may include various container modules performing different services. For example, one service, Lambda, may perform preprocessing, validation, or transformation of incoming data. Another service, Kinesis, may stream data for real-time or near-real-time ingestion into the system. Some embodiments may include the OpenSearch service or other search service to index and store data for querying, e.g. dish search, preference match.

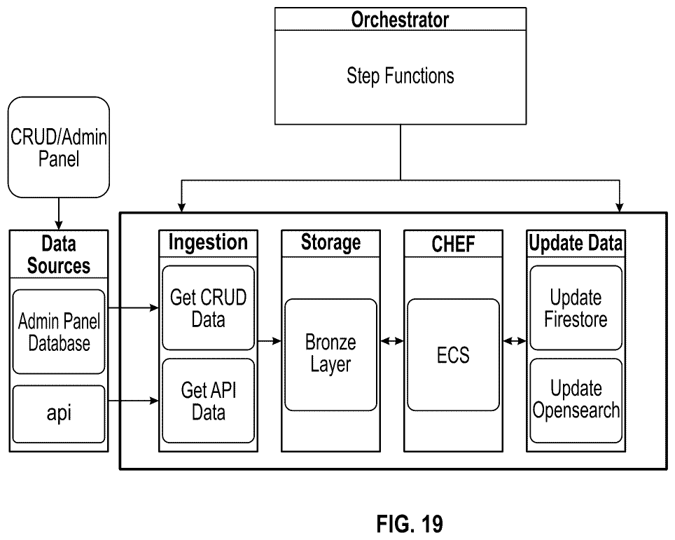

FIG. 19 shows a data pipeline similar to the pipeline architecture shown in FIG. 16, except without the missing image data feature that use AI to include an image when one is missing.

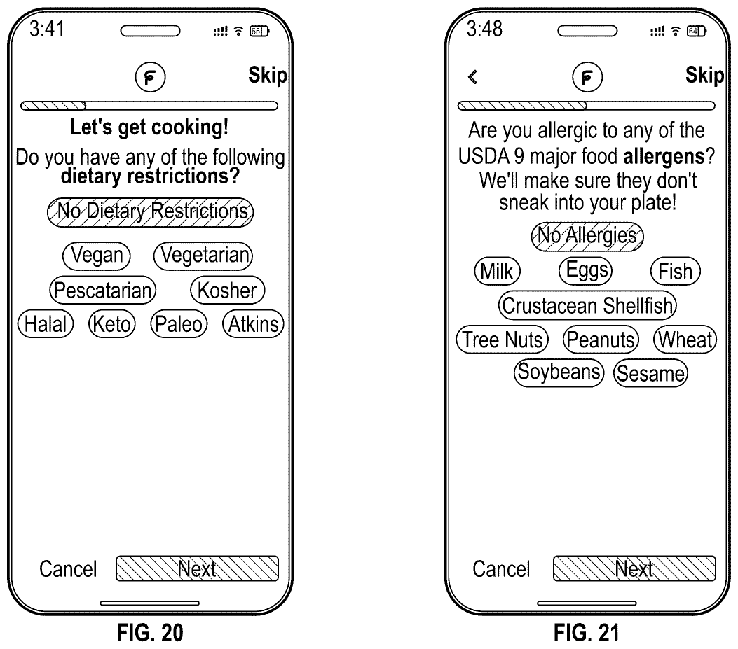

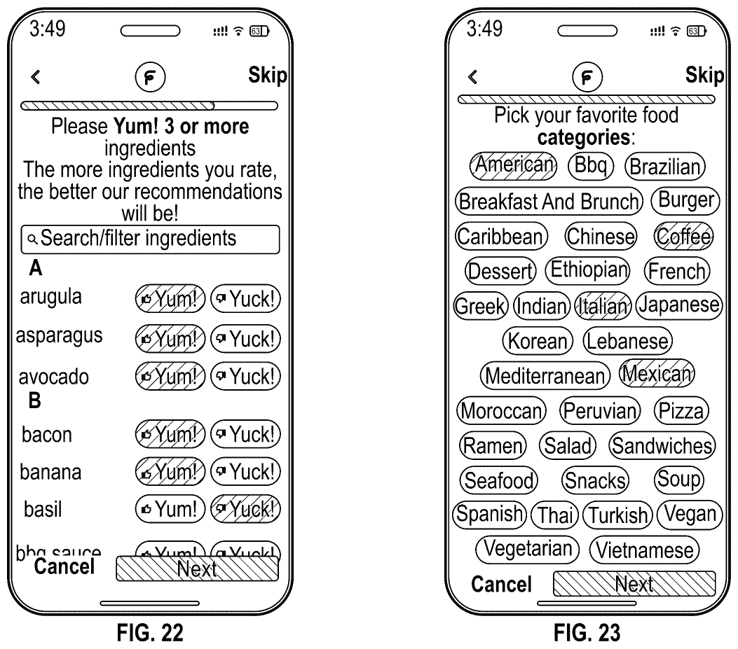

FIGS. 20-22 show various user interfaces as examples depicting features that may be included in the application 134. The user interface component enhances the food recommendation system functionality through expanded interaction capabilities and content presentation options. The interface elements shown provide users with enhanced navigation and discovery features that complement the personalized recommendation generation processes described in the previous figures. For example, some components may include interactive elements that allow users to explore different categories of food recommendations beyond the basic dish suggestions. FIG. 20 shows a UI that includes selectable items for the user to add dietary restrictions for the system to consider when making a recommendation. FIG. 21 shows a UI with selectable elements that a user may pick from, to add allergens in the consideration of food recommendations. FIG. 22 shows a UI that provides the user a list of food items from which the user can select whether the user likes the item or dislikes the item. The liked food items and disliked food items may be used by the system to determine food recommendations. FIG. 23 shows a UI that includes categories of food types that may be favorites that the system may use in determining food recommendations.

In some implementations of UIs, the interface elements may provide access to restaurant-specific menus, cuisine-type filtering options, and dietary preference refinement tools that enable users to customize their recommendation experience. The interface may present recommendation results through multiple viewing modes including list views, grid layouts, and detailed card presentations that accommodate different user preferences for information consumption.

While not shown, some implementations may incorporate social features in a UI that enable users to share recommendations with other users, view community ratings, and access reviews from users with similar taste profiles. In some cases, the social functionality may include following other users, creating shared recommendation lists, and participating in food-related discussions that enhance the overall user engagement with the recommendation system. The interface may display user-generated content including photos, reviews, and ratings that provide additional context for recommendation decisions.

### Computing Hardware and Software Support

Machine readable storage including machine-readable instructions, when executed, may implement a method or realize an apparatus in any of the examples of the present application. Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A computer program product for generating food recommendations, the computer program product comprising a non-transitory computer readable storage medium having program instructions embodied therewith, wherein an execution of the program instructions cause a processor to:
obtain, by a food recommendation engine, food item files from online sources;
identify ingredients from the food items;
tag the food item files with metadata identifying the ingredients;
generate a first set of vectors that represent values for each of the food items and the ingredients;
receive a plurality of food preference from a user input via a user interface of a software application run on a computing device;
identify one or more of the ingredients from the user input food preferences;
generate a second set of vectors that represent the user preferences based on the user input;
compare the first set of vectors to the second set of vectors;
select one or more vectors from the first set of vectors based on similarity scores calculated between the first set of vectors and the second set of vectors that meet or exceed a similarity threshold;
identify menu items and menu sources with one or more food items that match the selected vectors; and
display, by the food recommendation engine, the identified menu items as a recommendation on the user interface of the computing device operated by an end user.

2. The computer program product of claim 1, wherein the execution of the program instructions further causes the processor to:
receive one or more filters input by the end user into the user interface;
apply the filters to the identified menu items; and
display the recommendation with the filters applied to the menu items.

3. The computer program product of claim 1, wherein the execution of the program instructions further causes the processor to adjust the recommendation in real-time as one or more food preference values changes or a change in geographical position of the end user or computing device occurs.

4. The computer program product of claim 1, wherein the user input food preferences include one or more of food types liked by the end user, food types disliked by the end user, food items liked by the end user, and food items disliked by the end user.

5. The computer program product of claim 1, wherein the user input food preferences include dietary preferences of the user.

6. The computer program product of claim 1, wherein the user input food preferences include allergen restrictions.

7. The computer program product of claim 1, wherein the execution of the program instructions further causes the processor to:
determine one or more restaurant locations that one or more of the menu sources and provide the identified menu items in the recommendation; and
display the one or more restaurant locations in the user interface.

8. A computer implemented method for generating food recommendations, comprising:
obtaining, by a food recommendation engine, food item files from online sources;
identifying ingredients from the food items;
tagging the food item files with metadata identifying the ingredients;
generating a first set of vectors that represent values for each of the food items and the ingredients;
receiving a plurality of food preference from a user input via a user interface of a software application run on a computing device;
identifying one or more of the ingredients from the user input food preferences;
generate a second set of vectors that represent the user preferences based on the user input;
comparing the first set of vectors to the second set of vectors;
selecting one or more vectors from the first set of vectors based on similarity scores calculated between the first set of vectors and the second set of vectors that meet or exceed a similarity threshold;
identifying menu items and menu sources with one or more food items that match the selected vectors; and
displaying, by the food recommendation engine, the identified menu items as a recommendation on the user interface of the computing device operated by an end user.

9. The method of claim 8, further comprising:
receiving one or more filters input by the end user into the user interface;
applying the filters to the identified menu items; and
displaying the recommendation with the filters applied to the menu items.

10. The method of claim 8, further comprising adjusting the recommendation in real-time as one or more food preference values change or a change in geographical position of the end user or computing device occurs.

11. The method of claim 8, wherein the user input food preferences include one or more of food types liked by the end user, food types disliked by the end user, food items liked by the end user, and food items disliked by the end user.

12. The method of claim 8, wherein the user input food preferences include dietary preferences of the user.

13. The method of claim 8, wherein the user input food preferences include allergen restrictions.

14. The method of claim 8, further comprising:
determining one or more restaurant locations that one or more of the menu sources and provide the identified menu items in the recommendation; and
displaying the one or more restaurant locations in the user interface.

15. A computing device, comprising:
a processor; and
a memory coupled to the processor, the memory storing instructions to cause the processor to perform acts comprising:
obtaining, by a food recommendation engine, food item files from online sources;
identifying ingredients from the food items;
tagging the food item files with metadata identifying the ingredients;
generating a first set of vectors that represent values for each of the food items and the ingredients;
receiving a plurality of food preference from a user input via a user interface of a software application run on a computing device;
identifying one or more of the ingredients from the user input food preferences;
generate a second set of vectors that represent the user preferences based on the user input;
comparing the first set of vectors to the second set of vectors;
selecting one or more vectors from the first set of vectors based on similarity scores calculated between the first set of vectors and the second set of vectors that meet or exceed a similarity threshold;
identifying menu items and menu sources with one or more food items that match the selected vectors; and
displaying, by the food recommendation engine, the identified menu items as a recommendation on the user interface of the computing device operated by an end user.

16. The computing device of claim 15, wherein the instructions cause the processor to perform further acts comprising:
receiving one or more filters input by the end user into the user interface;
applying the filters to the identified menu items; and
displaying the recommendation with the filters applied to the menu items.

17. The computing device of claim 15, wherein the instructions cause the processor to perform further acts comprising adjusting the recommendation in real-time as one or more food preference values change or a change in geographical position of the end user or computing device occurs.

18. The computing device of claim 15, wherein the user input food preferences include one or more of food types liked by the end user, food types disliked by the end user, food items liked by the end user, and food items disliked by the end user.

19. The computing device of claim 15, wherein the user input food preferences include allergen restrictions.

20. The computing device of claim 15, wherein the instructions cause the processor to perform further acts comprising:
determining one or more restaurant locations that one or more of the menu sources and provide the identified menu items in the recommendation; and
displaying the one or more restaurant locations in the user interface.
